(19) United States
(12) Patent Application Publication
(10) Pub. No.: US 2025/0276383 A1
(43) Pub. Date: Sep. 4, 2025

(54) ADAPTIVE FOCUS FOR ADVANCED DIRECTED ENERGY DEPOSITION

(71) Applicants: Rolls-Royce Corporation, Indianapolis, IN (US); Rolls-Royce plc, London (GB)

(72) Inventors: Scott Nelson, Indianapolis, IN (US); Clive Grafton-Reed, London (GB); Peter E. Daum, Indianapolis, IN (US); David James Puhl, Indianapolis, IN (US)

(21) Appl. No.: 18/593,551

(22) Filed: Mar. 1, 2024

(51) Int. Cl. B22F 12/90; B22F 5/00; B22F 10/28; B22F 10/36; B22F 10/37; B22F 10/85; B22F 12/41; B22F 12/53; B22F 12/55; B33Y 30/00; B33Y 50/02; B33Y 80/00

(52) U.S. Cl. CPC B22F 12/90; B22F 5/009; B22F 10/28; B22F 10/36; B22F 10/37; B22F 10/85; B22F 12/41; B22F 12/53; B22F 12/55; B33Y 30/00; B33Y 50/02; B33Y 80/00

(57) ABSTRACT

An additive manufacturing system includes an energy delivery device configured to deliver energy to a build surface of an additively-manufactured component being manufactured to form a melt pool in the build surface of the component. The system further includes a powder delivery device, a melt pool monitor configured to observe the melt pool, and a computing device. The computing device is configured to receive, from the melt pool monitor, data indicative of one or more parameters of the melt pool and determine, based on the received data, a current position of the melt pool. The computing device is configured to determine a desired size of the melt pool based on the current position of the melt pool and control, based on the desired size of the melt pool, the energy delivery device to form the melt pool of the desired size in the build surface of the component.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing component to generate the three-dimensional structure. Additive manufacturing may be advantageous in many situations, such as rapid prototyping, forming components with complex three-dimensional structures, or the like. In some examples, additive manufacturing may utilize powdered materials and may melt or sinter the powdered material together in predetermined shapes to form the three-dimensional structures.

### SUMMARY

Additive manufacturing systems and techniques, such as directed energy deposition (DED) processes, operate by depositing material layer-by-layer to form an additively-manufactured component (hereinafter, “component”). In such processes, material is deposited by a powder delivery device directing a powder stream toward a melt pool formed on a build surface of the component by energy from an energy delivery device. The melt pool and added powder then solidify as an added layer. The added layer may become the new build surface for subsequent layers. In some examples, the powder delivery device and the energy delivery device may be parts of a common deposition head. The deposition head may travel along a toolpath to deposit a layer. In some examples, the toolpath may track back and forth across the build surface to deposit the layer. It may be beneficial to the performance and life of the component to uniformly apply the deposited layer. In some examples, for instance based on the geometry of the part, it may be desirable to vary the size of the melt pool to deposit a track of consistent thickness, microstructure, porosity, or the like.

Additive manufacturing systems and techniques according to the present disclosure may allow the size of the melt pool may be varied along a toolpath to deposit a track of material that varies in width. The size of the melt pool may be modified by changing the focus or working distance of the energy delivery device that forms the melt pool. The track of varying width may be uniformly and consistently applied as a layer by automatically modification of the power of the energy delivery device as the melt pool size changes, e.g., to maintain an energy density of the energy delivery device such that the melt pool, which has changed in size, may be kept at a substantially constant depth, temperature, or the like. In some examples, the powder delivery device may be modified such that powder from the powder stream may be added appropriately to a melt pool of changing size. In this way, a substantially uniform layer may be deposited on a complex geometry of the component in a single track, improving uniformity in composition and thickness of the resulting additively-manufactured component.

An example additive manufacturing system includes an energy delivery device configured to deliver energy to a build surface of an additively-manufactured component being manufactured to form a melt pool in the build surface of the component and a powder delivery device configured to direct a powder stream toward the melt pool. The additive manufacturing system also includes a melt pool monitor configured to observe the melt pool and a computing device. The computing device is configured to receive, from the melt pool monitor, data indicative of one or more parameters of the melt pool. The computing device is configured to determine, based on the received data, a current position of the melt pool. Based on the current position of the melt pool, the computing device may determine a desired size of the melt pool and control, based on the desired size of the melt pool, the energy delivery device to form the melt pool of the desired size in the build surface of the component.

An example additive manufacturing system includes delivering, via an energy delivery device, energy to a build surface of an additively-manufactured component being manufactured to form a melt pool in the build surface of the component. The technique includes delivering, via a powder delivery device, a powder stream to the melt pool to add material to the component. The technique also includes receiving, from a melt pool monitor, data indicative of one or more parameters of the melt pool. The technique includes determining, based on the received data, a current position of the melt pool. The technique includes determining, via the computing device, based on the position of the melt pool, a desired size of the melt pool. The technique includes controlling, via the computing device, based on the desired size of the melt pool, the energy delivery device to form the melt pool of the desired size in the build surface of the component.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating aspects of an example additive manufacturing system that includes a powder delivery device configured to direct a powder stream toward a melt pool formed by an energy delivery device.

FIG. 2 is a conceptual and schematic diagram illustrating further aspects of the additive manufacturing system of FIG. 1.

FIG. 3 is a conceptual block diagram illustrating portions of the example additive manufacturing system of FIG. 1.

FIG. 4 is a conceptual block diagram illustrating further aspects of the example additive manufacturing system of FIG. 1.

FIG. 5 is a process flow diagram illustrating a mass flux monitoring, heat flux monitoring, and melt pool monitoring and control technique.

FIG. 6 is a conceptual and schematic diagram illustrating operation of a deposition head during an additive manufacturing process.

FIG. 7 is a conceptual and schematic diagram illustrating operation of the deposition head of FIG. 6 at another point in time during the additive manufacturing process.

FIGS. 8A-8D are conceptual and schematic diagrams illustrating a deposition head depositing a track of varying width on a component from an isometric view.

FIGS. 9A and 9B are conceptual views of an example additively-manufactured component from a side and top view, respectively.

FIGS. 10A-10C are conceptual and schematic diagrams illustrating a deposition head depositing a layer of material on a build surface that includes a deviation.

FIG. 11 is a flow diagram illustrating an example technique according to the present disclosure.

### DETAILED DESCRIPTION

The disclosure generally describes techniques and systems for depositing a track of varying width during an additive manufacturing technique, such as a directed energy deposition (DED) technique. During DED additive manufacturing, a component is built up by adding material to the component in sequential layers. The final component is composed of a plurality of layers of material. In some blown powder additive manufacturing techniques for forming a component or a coating on a component from metals, ceramics, alloys, or combinations thereof, an energy source may direct energy at a substrate to form a melt pool. A powder delivery device may deliver a powder to the melt pool, where at least some of the powder at least partially melts and is joined to the melt pool and, thus, the substrate. In some examples, the powder delivery device and the energy delivery device may each be parts of a common deposition head configured to deliver both powder and energy to the build surface. In such cases, the deposition head may travel along a toolpath in a pattern to deposit a layer, for example, by passing back and forth across the build surface, with each pass laying down a track of deposited material.

The properties of the final component, including the presence or absence of material defects (e.g., pores or void spaces, thickness of each of the plurality of layers, material not joined to adjacent material, and the like), and the efficiency with which material is added to the component, may be a function of the interaction between the powder stream, the melt pool, and the component. As such, measurement, modeling, control, and validation of the position of the powder stream from the powder delivery device, the melt pool formed by the energy delivery device, and the component may enable characterization or prediction of final component properties, control of the additive manufacturing technique during the process, quality assurance for the final component, development of new additive manufacturing techniques, and the like.

Challenges may arise while performing additive manufacturing techniques with additive manufacturing systems. For example, the component may define a complex geometry. For example, when forming a gas turbine engine component such as an airfoil blade by additive manufacturing, the build surface may vary in width, and at certain points the build surface may be narrow relative to other portions of the build surface. Deposition of a track of material on such a narrow portion of the build surface may require a melt pool that is small in size (e.g., diameter), such that the melt pool does not cause melting over the edge of the build surface. Conversely, however, deposition of a narrow track of material on areas of the build surface which are less narrow may lead to an inefficient additive manufacturing process, since additional passes of the deposition head over the build surface, with each pass laying down a narrow track, may be required to deposit the entire layer. Furthermore, adjacent tracks of material may differ slightly between each other in, for example, in or more of a thickness, microstructure, porosity, or the like. Where possible, it may be desirable to apply a layer on the build surface as a single track to avoid such differences. Accordingly, in addition to gains in efficiency, deposition of a layer in a single pass of a deposition head may improve uniformity of the deposited layer.

In accordance with one or more examples of the current disclosure, additive manufacturing systems and techniques may address these and other challenges. Additive manufacturing systems according to the present disclosure may include an energy delivery device configured to deliver energy to a build surface of an additively-manufactured component to form a melt pool in the build surface of the component and a powder delivery device configured to direct a powder stream toward the melt pool. The system may include a powder flow monitoring system (PFMS) configured to observe the powder stream and a melt pool monitor configured to observe the melt pool. The system may also include a computing device. The computing device may receive, from melt pool monitor, data indicative of one or more parameters of the melt pool. The computing device may determine, based on the received data, a position and/or a current size of the melt pool. The computing device may determine, based on the position melt pool, a desired size of the melt pool. The computing device may control, based on the determined desired size of the melt pool, the energy delivery device to form the melt pool of the desired size in the build surface of the component. In some examples, controlling the energy delivery device to form the melt pool of the desired size in the build surface may include modifying the energy delivery device to adjust the size of the melt pool.

Adjusting the size of the melt pool formed in the build surface may result in deposition of a track or tracks of varying width on the component. Such variation may advantageously allow for formation of narrow geometric features on the component because addition of material to a relatively small melt pool on the component may deposit a narrow track of material, and thus may build a correspondingly narrow feature as the added layer. Additionally, or alternatively, varying the size of the melt pool may increase the efficiency of manufacture by allowing for a reduced number of tracks in relatively wide areas of the build surface through formation of a relatively large melt pool on the build surface. Still further, variation in the size of the melt pool may improve uniformity of the resulting component because variation in the size of the melt pool may allow for a single pass of the deposition head to deposit an entire layer, even when the build surface varies in width, which may improve conformity of the thickness, microstructure, porosity, composition, or the like of the deposited layer.

The computing device may automatically vary the melt pool size in-situ during the additive manufacturing process, which may improve the efficiency and quality of the process relative to additive manufacturing systems which must be stopped and/or manually adjusted to vary the melt pool size. For example, the energy delivery device may be a laser which delivers an energy beam which impinges on the build surface to form the melt pool. The size of the melt pool may be defined by the greatest dimension of the melt pool in a plane parallel to the build surface. Typically, the energy beam and the melt pool have a substantially elliptical cross-sectional area in a plane parallel to the build surface such that the greatest dimension of the melt pool is the melt pool diameter, but other shapes are also considered. For example, one or more shields or other occlusion devices may be employed to block some of the energy beam to change the shape of the melt pool, and the size of the melt pool may be defined by the greatest dimension of the resulting melt pool. The melt pool may be varied in size by modification of the focus of the laser (e.g., by adjustment of a lens and/or mirror system) such that the spot size of the laser on the build surface may be made larger or smaller. The melt pool may form in the build surface at the laser spot. Additionally, or alternatively, modification of the working distance, which is the distance between the energy delivery device and the build surface, may be employed to vary the melt pool size, in addition to or alternatively to modification of the focus.

To vary the melt pool size, the computing system may control the energy delivery device to form the melt pool of the desired size in the build surface. The desired melt pool size may be determined in any suitable way. For example, to determine the desired size of the melt pool, the computing device may store a model of a final fully-formed version of the additively-manufactured component (e.g., finished component). The model of the fully-formed additively-manufactured component may be divided into a matrix with a plurality of cells. For example, the matrix may include a plurality of rows, with each row corresponding to a layer of the plurality of layers of the component and plurality of columns, with each column corresponding to a portion of a plurality of portions of the component. The model may store desired melt pool sizes at each cell of the matrix, along with other aspects of the build strategy (e.g., system settings such as power supplied to the energy delivery device, mass flux, powder density, carrier gas flow rate, etc.). The computing system may determine the current position of the melt pool, determined based on received data from a melt pool monitor, and may compare the current position of the melt pool to the model of the fully formed additively-manufactured component to determine the location of the melt pool within the model, that is, which cell in the matrix contains the desired melt pool size corresponding to the particular position. The computing device may thus determine the desired size of the melt pool based at partially on the model of the fully formed version of the additively-manufactured component.

Other ways to determine the desired size of the melt pool are considered. For example, in some examples, a track may be positioned at an edge of the component, and the additive manufacturing system may deposit a track that aligns with the edge, even when the complex geometry of the component requires that the track vary in width. In some examples, the computing device may receive, from the melt pool monitor, data indicative of the geometry of the build surface (e.g., edges of the build surface) in addition to one or more parameters of the melt pool. The computing device may determine at least one boundary of the build surface based on the received data, and determine the desired size of the melt pool based at least partially on the determined boundary or boundaries. In this way, by sensing an edge or edges of the component, the additive manufacturing system may deposit a layer with the same or similar dimensions as the underlying layer without causing melting over the edge of the layer by modifying the size of the melt pool, and thus the resulting track of deposited material, to conform to the edge of the component.

Still other ways to determine the desired size of the melt pool are considered. For example, a topology sensor, which in some cases may be a laser profilometer, may scan the build surface and output data indicative of the topology of the build surface in the area of the melt pool. The computing device may receive the topological data from the topology sensor and identify, based on the received data, a deviation in the build surface. For example, the received topological data may be compared to specification data representative of a set of tolerances of the build surface to identify the deviation. The deviation may be a depression or crack in the build surface, or may be a relatively high area such as a ridge or protrusion. The deviation may result from melt pool splatter, unmelted powder from the powder stream adhering to the build surface, or the like. The computing device may control the energy delivery device to modify the size of the melt pool in the vicinity of the build surface where the deviation is recognized, based on an algorithm, look-up-table, machine learning model, or the like. The algorithm, look-up-table, or machine learning model may store or output a desired melt pool size for the identified deviation.

In some examples, machine learning may be used to identify the correct or target melt pool size at various positions within the volume of the build for given materials, component geometry and set of deposition parameters. By producing a known build of good quality, the melt pool shape presented to the sensing device and then collecting analyzing the images, a point-to-point and/or moment-to-moment target melt pool size can be derived from the data.

In cases where a machine learning model is used, the machine learning model may be trained on data from previously identified deviations and/or corrective actions. For example, a protrusion cause by unmelted powder at the build surface may be identified and at least partially repaired by increasing the size of the melt pool at or near the protrusion, which may melt the unmelted powder and/or flatten the build surface in the area of the protrusion. In this way, aspects of the current disclosure may allow for in-situ monitoring and corrective action of the additive manufacturing process where the melt pool may be varied in size to improve the quality of the resulting component.

To control the energy delivery device to form the melt pool of the desired size, the system may include logic for deciding whether an adjustment to the melt pool size is necessary. For example, the computing device may determine whether the current size of the melt pool meets a threshold for matching the desired size of the melt pool. Responsive to determining that the current size of the melt pool does not meet the threshold for matching the desired size of the melt pool, the computing device may adjust the size of the melt pool by modifying the energy delivery device (e.g., adjust the focus or working distance of the energy delivery device). In some examples, the melt pool may be substantially elliptical or circular, and may vary in diameter from about 0.1 millimeters (mm) to about 5 mm, such as from about 0.4 mm to about 3 mm. In some examples, the threshold for matching the desired size of the melt pool may be about plus or minus (+/−) 5 percent (%), or about 10%, or about 20%.

Varying the melt pool in size during the deposition may allow for varying the width of the deposited track, but if other settings of the system are not modified (e.g., proportionally modified), the track may vary in porosity, composition, microstructure, or the like as the track varies in width. It may be desirable, for increased quality of the final component, to deposit a track that is uniform in parameters other that the varying width. In conventional systems, many parameters are not manipulable during operation of the additive manufacturing system, or may be tied to other settings such that changing one setting forces other settings to change. For example, some additive manufacturing systems require that a convergence point of the powder stream change if the melt pool size changes, which may not be desirable in all circumstances. Aspects of the current disclosure relate to additive manufacturing systems and techniques that allow for independent manipulation of settings under control of the computing device. Decoupling, for example, the powder delivery device and the energy delivery device such that each device is independently controllable may allow for selective tailoring of process settings under control of the computing device. In this way, the computing device may control the settings and operation of the energy delivery device and the powder delivery device to respond appropriately to a melt pool that varies in size.

For example, if the powder stream is directed in the same volume and direction at a melt pool that varies between relatively small and relatively large sizes, powder from the powder stream may be added to a different point in the melt pool at a different volume or may miss the melt pool altogether, reducing the capture efficiency of the melt pool. It may be desirable to add powder from the powder stream to the melt pool in a way that varies according to the changing size of the melt pool. For example, the powder delivery device may include one or more delivery nozzles from which the powder stream is directed, and the computing device may control a position of the one or more delivery nozzles to change the way powder is added to the melt pool as the melt pool varies in size. In some examples, the powder delivery device includes a plurality of delivery nozzles where individual portions of the powder stream are directed from each delivery nozzle of the plurality of delivery nozzles. The individual portions of the powder stream may be configured to converge at a convergence point. The computing device may, responsive to a change in the size of the melt pool, adjust the powder delivery device (e.g., an angle of the delivery nozzles) to modify the convergence point. In this way, the powder stream may be controlled as the melt pool size varies to maintain capture efficiency, component properties, or the like.

Varying the melt pool size without varying other settings of the energy delivery device may be problematic. For example, if the melt pool is made larger or smaller without varying the power supplied to the energy delivery device, the energy density of the energy beam forming the melt pool will increase or decrease. The energy density may be considered the units of energy impinging upon the build surface divided by the area of the melt pool. Changing the energy density of the energy beam supplied to the melt pool may deleteriously impact the temperature of the melt pool and ultimately the way in which material is added to the melt pool and cooled to form a new layer.

According to aspects of the current disclosure, the computing device may maintain a power density of the energy delivery device by adjusting the power supplied to the melt pool proportionally to the adjustment of the size of the melt pool. For example, to maintain the energy density of the melt pool, the computing device may increase the powder supplied to the energy delivery device as the melt pool grows in size and reduce the power supplied to the melt pool as the melt pool shrinks in size. In this way, material may be added and joined to melt pools of relatively smaller and relatively larger size in a uniform manner, and narrow geometric features of the deposited layer and larger areas of the layer may share final material properties. Although primarily discussed herein as maintaining the energy density, in some examples the computing device may increase or decrease the energy density of the energy beam responsive to a change in the size of the melt pool.

One or more aspects of the present disclosure may be used to account for the way an edge or a topological deviation cause the melt pool to appear to the melt pool monitor. As deposition moves over the build surface, the melt pool size and geometry will change depending on the location of the melt pool to the underlying shape. At edges or corners, as the melt pool rolls over the edge, the melt pool may appear smaller to the camera than in the center section of the build. The melt pool will also appear differently to the camera as it travels up or down an incline or over a wavy surface. For example, the size and/or shape of the melt pool may distort when the melt pool is positioned on or near a topological deviation in the build surface. According to aspects of the present disclosure, the desired size of the appearance of the melt pool to the melt pool monitor may be determined, based on the underlying geometry of the component. In some examples, the computing device may store a model of the actual size of the melt pool based on the predicted distortion or disappearance of the melt pool by the melt pool monitor. In some examples, data captured by the melt pool monitor during deposition on one layer in real time and then feeding back that information into the deposition of the subsequent layer will allow for a more accurate assessment and choosing of the correct target melt pool size.

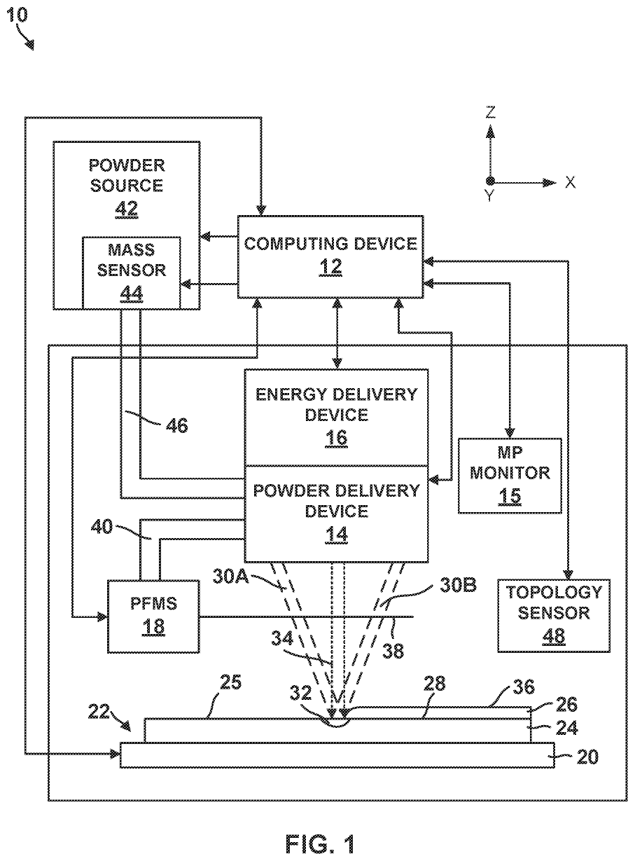

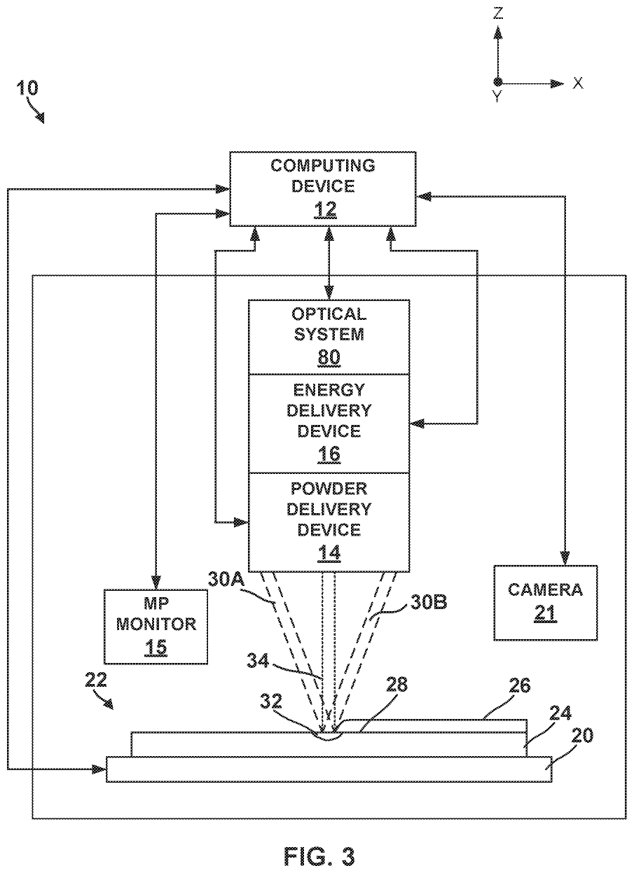

FIG. 1 is a conceptual block diagram illustrating aspects of an example additive manufacturing system 10. Additive manufacturing system 10 includes several components configured to monitor mass flow, and several components configured to monitor energy (e.g., heat flux) within system 10. System 10 includes a powder source mass sensor 44, a powder flow monitoring system (PFMS) 18, and a topology sensor 48. These components are configured to monitor mass flow of powder within additive manufacturing system 10 during an additive manufacturing technique. System 10 also includes melt pool monitor 15, and includes other components which measure and monitor heat flux within system 10, which are further described with respect to FIG. 3. As such, to simplify illustration of FIG. 1 and improve clarity of the figure, further aspects of additive manufacturing system 10 are shown in FIG. 3 and described below with reference to FIG. 3, which is more directed toward heat flow aspects of system 10. In the example illustrated in FIG. 1, additive manufacturing system 10 further includes a computing device 12, a powder delivery device 14, an energy delivery device 16, a stage 20, a powder source 42, powder source mass sensor 44, and topology sensor 48. Computing device 12 is operably connected to powder delivery device 14, energy delivery device 16, PFMS 18, stage 20, powder source 42, powder source mass sensor 44, and topology sensor 48. FIG. 1 thus illustrates mass flow monitoring and other aspects of example additive manufacturing system 10.

Stage 20 is configured to mechanically support a component 22 during an additive manufacturing technique. Component 22 may be considered in-situ when mechanically supported by stage 20. In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. For example, stage 20 may be translatable and/or rotatable along at least one axis to position component 22 relative to energy delivery device 16 and/or powder delivery device 14. Similarly, energy delivery device 16 and/or powder delivery device 14 may be translatable and/or rotatable along at least one axis to position energy delivery device 16 and/or powder delivery device 14, respectively, relative to component 22. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream.

System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1, for at least part of flow path 46 between powder source 42 and nozzles of powder delivery device 14, flow path 46 may split into multiple, parallel sections, e.g., one for each nozzle. Further, although not shown in FIG. 1, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more delivery nozzles that each output a portion powder as powder streams 30A and 30B. Portions 30A and 30B may converge at a convergence point (e.g., at build surface 28) to define powder stream 30. In some examples, where the convergence point is below build surface 28, portions 30A and 30B of powder stream 30 may not converge, and rather enter melt pool 32 at different points before having a chance to converge. In some examples, powder delivery device 14 includes a single delivery nozzle, which may be point nozzle, or a single delivery nozzle that is an annular channel. In other examples, powder delivery device 14 includes a plurality of delivery nozzles (e.g., three nozzles or four nozzles). Regardless of the number of delivery nozzles, powder delivery device 14 may output a powder stream that is focused at a focus plane, which may also be called a convergence point. The convergence point may be the point at which powder streams 30A and 30B meet to form powder stream 30. As powder delivery device 14 is movable in the z-axis shown in FIG. 1 relative to component 22, the convergence point of powder stream 30 also may be movable in the z-axis relative to component 22, such that the focus plane may be controlled to be substantially coincident with build surface 28. In some examples, the convergence point may be below build surface 28, such that powder streams 30A and 30B are added to melt pool 32 as separate powder streams. In some examples, the convergence point of powder stream 30 may be manipulated even without moving powder delivery device 14 in the z-direction, such as by adjusting the angle of the delivery nozzles of powder delivery device 14.

At least some of the powder in powder stream 30 may impact a melt pool 32 in component 22. At least some of the powder that impacts melt pool 32 may be joined to component 22. In some examples, powder delivery device 14 may be mechanically coupled or attached to energy delivery device 16 to facilitate delivery of powder stream 30 and energy beam 34 for forming melt pool 32 to substantially the same location adjacent to component 22. As will be further described below, the size of melt pool 32, which may be defined as the greatest dimension in a plane parallel to build surface 28 at the center of melt pool 32, may be adjustable by control of energy delivery device 16. For example, increasing the focus of energy beam 34 such that it defines a smaller cross-sectional area may cause melt pool 32 to shrink in size, while reducing the focus of energy beam 34 may cause melt pool 32 to enlarge in size. In some examples, reducing the working distance, or distance from energy delivery device 16 may cause melt pool 32 to shrink in size, and increasing the working distance may cause melt pool 32 to enlarge in size.

Energy delivery device 16 may include an energy source, such as a laser source, an electron beam source, plasma source, or another source of energy that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, or direct energy beam 34 toward predetermined positions at or adjacent to build surface 28 of component 22 during the additive manufacturing technique. As described above, in some examples, the energy delivery head may be movable in at least one dimension (e.g., translatable and/or rotatable) under control of computing device 12 to direct energy 34 toward a selected location at or adjacent to build surface 28 of component 22. Energy delivery device 16 may be configured to focus energy 34 from the energy source on a local spot on build surface 28 to generate melt pool 32. As will be further described below, energy delivery device 16 may include one or more mechanisms to adjust the size of energy beam 34 and thus melt pool 32. For example, energy delivery device 16 may direct energy 34 through an optical system that includes one or more mirrors and/or one or more lenses, which may be manipulated to manipulate the focus of energy beam 34. Additionally, or alternatively, energy delivery device 16 may be mounted on one or more adjustable support members, which may be adjusted by computing device 12. The galvanometers, lenses, and/or adjustable support members may be adjusted by computing device 12 to modify and selectively tailor the size of energy beam 34, and, accordingly, the position of melt pool 32 on build surface 28.

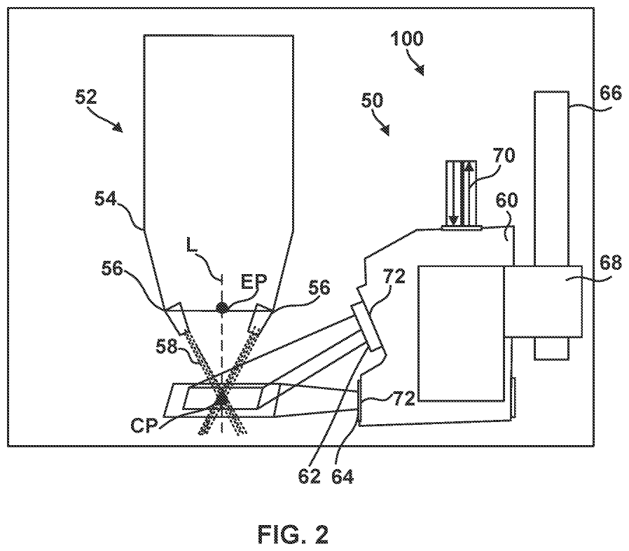

In some examples, at least a portion of energy delivery device 16 and powder delivery device 14 may be combined or attached to each other. For example, a deposition head (e.g., deposition head 54 of FIG. 2) may include part of powder delivery device 14 (e.g., internal channels and powder delivery nozzle(s) 56 for forming powder streams 30A and 30B, which converge as powder stream 30) and part of energy delivery device 16 (e.g., the energy delivery head). As shown in FIG. 1, in some examples, primary energy delivery device 16 may be arranged of configured such that energy 34 and powder stream 30 both exit from a common deposition head (54, FIG. 2) and are directed toward build surface 28. For instance, energy 34 may pass through a central channel (e.g., formed along central longitudinal axis L, FIG. 2) within the deposition head and exit a central aperture in the deposition head, while fluidized powder may flow through internal channels and powder nozzle(s) 56 for forming powder stream 30 and directing powder stream 30 toward build surface 28. Such an arrangement between primary energy source 16 and powder delivery device 14 may be called an “on-axis” arrangement of energy source 16, because both energy and powder may be delivered coaxially with a central longitudinal (Z-direction) axis of the deposition head.

System 10 also includes powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light sources. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28 (e.g., central longitudinal axis L).

The imaging device of PFMS 18 is configured to image at least some of the illuminated powder. The imaging device may have a relatively high data acquisition speed (e.g., frame rate), such greater than 1000 Hz. Because of the velocity of the powder in powder stream 30, even such a frame rate may image only a fraction of the powder flowing between powder delivery device 14 and build surface 28. In some examples, the imaging device may be a camera.

In some examples, PFMS 18 also includes a housing configured to enclose the illumination device and the imaging device. The housing may be configured to protect the illumination device and the imaging device from damage due to the harsh conditions to which PFMS 18 may be exposed during use. For example, the housing may protect the illumination device and the imaging device from powder deflections from powder stream 30 off build surface 28, may cool the illumination device and the imaging device to remove heat incident on PFMS 18 from melt pool 32 and energy delivery device 16, or the like.

PFMS 18 may be positionally fixed relative to powder delivery device 14 and/or energy delivery device 16, e.g., in the x-y plane shown in FIG. 1. This may help maintain a relative x-y position of PFMS 18 and the image plane of the imaging device relative to powder stream 30. This may facilitate analysis of image data captured by the imaging device.

PFMS 18 may be movable in the z-axis direction of FIG. 1 (e.g., parallel to a longitudinal axis extending from powder delivery device 14 to build surface 28). This may enable movement of image plane 38 along the z-axis of FIG. 1 (e.g., parallel to a longitudinal axis extending from powder delivery device 14 to build surface 28). This may allow PFMS 18 to image powder stream 30 at different positions between powder delivery device 14 and build surface 28. In this way, PFMS 18 may analyze powder stream 30 along powder stream 30 to help determine parameters of powder stream 30 along its length.

In some example, PFMS 18 may be positionally fixed relative to powder delivery device 14 and/or energy delivery device 16 and movable parallel to a longitudinal axis extending from powder delivery device 14 to build surface 28 by an adjustable z-stage 40. Adjustable z-stage 40 may be attached to energy delivery device 16, powder delivery device 14, or a portion of system 10 that moves energy delivery device 16 and/or powder delivery device 14, such that PFMS 18 moves in the x-y axis in registration with energy delivery device 16 and/or powder delivery device 14.

Adjustable z-stage 40 may be controlled by computing device 12 to position PFMS 18 and image plane 38 relative to powder stream 30. Further, computing device 12 may control adjustable z-stage 40 to move PFMS 18 vertically and out of the way to allow powder delivery device 16 and energy delivery device 16 access to physically constrained areas, e.g., between vanes of a doublet or triplet of a nozzle guide vane for a gas turbine engine.

System 10 further includes a topology sensor 48. Topology sensor 48 is configured to monitor an amount of powder captured by melt pool 32 by imaging melt pool 32 and the added material, allowing the mass to be quantified (e.g., by computing device 12) using the dimensions of the added material and density of the material (powder). In some examples, topology sensor 48 includes a laser and a sensor (e.g., an imaging device, such as a camera), which senses laser light reflected by the structure being imaged (e.g., melt pool 32 and the added material). Such a device may be called a laser profilometer. The laser may have a defined wavelength, which may affect the resolution of the topology sensor 48. In some examples, the wavelength and sensor may be selected such that the resolution of topology sensor 48 is a great as about 10 microns (e.g., about 6 microns).

In some examples, topology sensor 48 may be positioned substantially directly above component 22 (e.g., along a central axis of powder delivery device 14, energy delivery device 16, or a common deposition head that includes both powder delivery device 14 and energy delivery device 16) and may include an interferometer, which provides depth information based on the time from outputting a laser pulse to the sensing of the reflected light. In other examples, topology sensor 48 may be positioned at an offset with respect to component 22 such that the sensor senses depth information without using an interferometer.

In some examples, topology sensor 48 may be integral with system 10, e.g., disposed within the enclosure or working area of system 10. In other examples, topology sensor 48 may be an add-on component to system 10. For example, the enclosure in which the additive manufacturing technique is performed may include a transparent window, and topology sensor 48 may be positioned outside of the enclosure and may image component 22 through the transparent window.

Although a topology sensor 48 is described in the examples of this disclosure, in other examples, another metrology device may be utilized to determine the amount of powder captured by melt pool 32. For example, another type of light source may be used. In some examples, if another type of light source is used, component 22 or stage 20 may include one or more features that serve as indicators of scale. Furthermore, although described as a single topology sensor 48, more than one sensor may be used, and may employ more than one of the technologies described above.

Computing device 12 may control components of system 10 and may include, for example, a desktop computer, a laptop computer, a workstation, a server, a mainframe, a cloud computing system, or the like. Computing device 12 may control operation of system 10, including, for example, powder delivery device 14, energy delivery device 16, PFMS 18, stage 20, powder source 42, powder source mass sensor 44, topology sensor 48, and/or further elements of system 10, such as melt pool (MP) monitor 15. Computing device 12 may be communicatively coupled to powder delivery device 14, energy delivery device 16, PFMS 18, stage 20, powder source 42, powder source mass sensor 44, MP monitor 15, and/or topology sensor 48 using respective communication connections. In some examples, the communication connections may include network links, such as Ethernet, ATM, or other network connections. Such connections may be wireless and/or wired connections. In other examples, the communication connections may include other types of device connections, such as USB, IEEE 1394, or the like.

Computing device 12 may include one or more processors. Example of processors include, but are not limited to, one or more microprocessors, digital signal processors (DSPs), application specific integrated circuits (ASICs), field programmable gate arrays (FPGAs), or any other equivalent integrated or discrete logic circuitry, as well as any combinations of such components. Computing device 12 may include a memory, and the memory may store instructions for various operations of system 10.

Although FIG. 1 illustrates a single computing device 12 and attributes all control and processing functions to that single computing device 12, in other examples, system 10 may include multiple computing devices 12, e.g., a plurality of computing devices 12. In general, control and processing functions described herein may be divided among one or more computing devices. For instance, system 10 may include a controller for energy delivery device 16, powder delivery device 14, and stage 20, a separate controller for PFMS 18, and a separate computing device for analyzing data obtained by PFMS 18, mass sensor 44, MP monitor 15, and topology sensor 48. As another example, system may include a dedicated controller for each of energy delivery device 16, powder delivery device 14, stage 20, PFMS 18, MP monitor 15, and topology sensor 48, and a separate computing device for coordinating control of powder delivery device 14, energy delivery device 16, PFMS 18, stage 20, powder source 42, powder source mass sensor 44, and/or topology sensor 48 and analyzing data obtained by PFMS 18, MP monitor 15, powder source mass sensor 44, and/or topology sensor 48. Other examples of computing system architectures for controlling system 10 and analyzing data obtained from system 10 will be apparent and are within the scope of this disclosure.

Computing device 12 may control operation of powder delivery device 14, energy delivery device 16, adjustable z-stage 40, stage 20, MP monitor 15, and/or topology sensor 48 to position component 22 relative to powder delivery device 14, energy delivery device 16, PFMS 18, MP monitor 15, and topology sensor 48. For example, as described above, computing device 12 may control stage 20 and powder delivery device 14, energy delivery device 16, adjustable z-stage 40, and/or topology sensor 48, to translate and/or rotate along at least one axis to position component 22 relative to powder delivery device 14, energy delivery device 16, PFMS 18, MP monitor 15, and topology sensor 48. Positioning component 22 relative to powder delivery device 14, energy delivery device 16, PFMS 18, MP monitor 15, and topology sensor 48 may include positioning a predetermined surface (e.g., build surface 28, a surface to which material is to be added) of component 22 in a predetermined orientation relative to powder delivery device 14, energy delivery device 16, PFMS 18, and/or topology sensor 48.

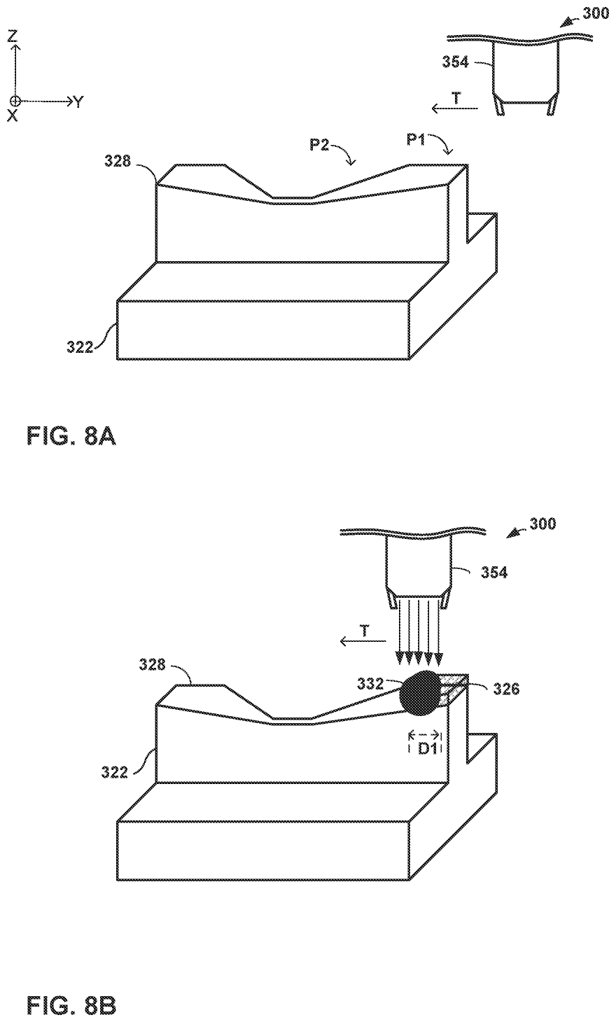

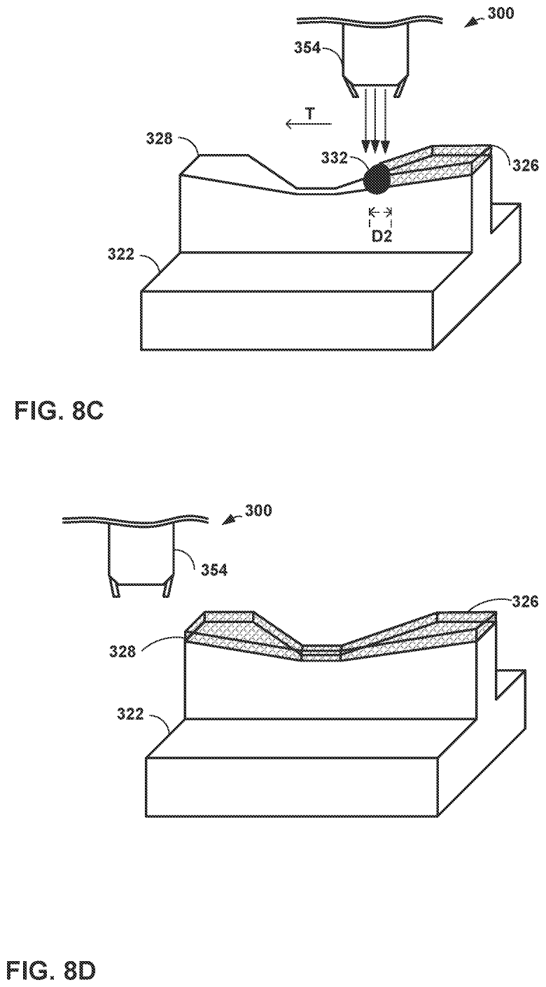

Computing device 12 may control system 10 to deposit layers 24 and 26 to form component body 25 and eventually finished component 22. As shown in FIG. 1, component 22 may include a first layer 24 and a second layer 26, although many components may be formed of additional layers, such as tens of layers, hundreds of layers, thousands of layers, or the like. Component 22 in FIG. 1 is simplified in geometry and the number of layers compared to many components formed using additive manufacturing techniques, as described and illustrated with respect to FIGS. 8A-8D below. Although techniques are described herein with respect to component 22 including first layer 24 and second layer 26, the technique may be extended to components 22 with more complex geometry and any number of layers. Furthermore, although component 22 is illustrated as being uniform, in some examples component 22 may be functionally-graded and include at least two different portions having different selectively tailored properties.

To form component 22, computing device 12 may control powder delivery device 14 and energy delivery device 16 to form, on build surface 28 of first layer 24 of material, a second layer 26 of material using an additive manufacturing technique. Computing device 12 may control energy delivery device 16 to deliver energy beam 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32. The position of powder stream 30 and melt pool 32 may be independently controlled by computing device 12, such that the relative position of powder stream 30 to melt pool 32 may be selectively controlled as part of an additive manufacturing technique, in accordance with examples of this disclosure. The relative position of powder stream 30 to melt pool 32 may even be independently controlled when powder delivery device 14 and energy delivery device 16 are parts of a common deposition head (54, FIG. 2). Such independent control of powder delivery device 14 and energy delivery device 16 during an additive manufacturing process may permit adjustment of the relative position of powder stream 30 to melt pool 32 to account for settings and parameters of system 10 during operation. Computing device 12 may control energy delivery device 16 to cause a change in the size of melt pool 32, such as by a modification of the focus or z-axis position of energy delivery device 16.

Computing device 12 may then control a z-axis position of stage 20 and/or powder delivery device 14 and energy delivery device 16 such that melt pool 32 will be formed on surface 36 of second layer 26, and may control powder delivery device 14 and energy delivery device 16 to move energy 34 and powder stream 30 along build surface 28 in a pattern until layer 26 is complete. Each individual pass in the pattern may be called a track, such that layer 26 is made up of a plurality of adjacent tracks. Computing device 12 may control powder delivery device 14 and energy delivery device 16 similarly until all layers are formed to define a completed component 22.

Computing device 12 may control powder delivery device 14 and primary energy delivery device 16 to move energy 34 and powder stream 30 along build surface 28 in a pattern until layer 26 is complete. As mentioned above, powder delivery device 14 and energy delivery device 16 may be parts of a common deposition head, and computing device 12 may control the deposition head (54, FIG. 2) to move along a toolpath to deposit layer 26. Computing device 12 may receive, from PFMS 18, data indicative of the position of powder stream 30. Computing device 12 may also receive, from MP monitor 15, which is configured to observe the melt pool, data indicative of a current position and size of melt pool 32 on build surface 28. The current position of melt pool 32 may be defined relative to common deposition head (54, FIG. 2), which may be defined within system 10. Additionally, or alternatively, the current position of melt pool 32 be defined with respect to a fully formed version e.g., a point cloud model of dimensions, of final component 22. In other words, computing device 12 may store a model of the desired finished component 22. The model may be a matrix with a plurality of rows, each row representing a layer 26, and a plurality of columns, each column representing a portion of component 22. Computing device 12 may store, at each location in the matrix, a build strategy for component 22. The build strategy may include various operational settings of system 10. The build strategy may include a desired size of melt pool 32, and may include settings of energy delivery device 12 (e.g., focus settings, power supplied, etc.) to achieve the desired size of melt pool 32. In this way, the desired size of melt pool 32 may be determined based on the location of melt pool 32 within the model of the desired final component 22.

In some examples, computing device 12 may store/execute one or more machine learning models which may be used to adapt control of powder delivery device 14, primary energy delivery device 16, or another component. For example, data captured by MP monitor 15, energy delivery device 16, PFMS 18, topology sensor 48, mass source 44, or other components of system 10 may be used to train the machine learning device. Furthermore, additional parameters of system 10 may be inputs to a machine learning model, such as operational settings of system 10.

In some examples, the machine learning model stored and executed by computing device 12 machine learning may be used to identify the correct or target melt pool size at various positions within the volume of the build. For example, the machine learning model may include inputs that include the given materials, component 22 geometry and deposition parameters of system 10. The size of melt pool 32 may also be an input to the machine learning model. By producing a known build of good quality, the melt pool shape presented to the sensing device and then collecting analyzing the images, a point-to-point and/or moment-to-moment target melt pool size can be derived from the data.

The machine learning model may also be used to account for the way an edge or a topological deviation in component 22 may cause melt pool 32 to appear in the data captured by melt pool monitor 15. For example, as deposition moves over build surface 28, the melt pool size and geometry of melt pool 32 may change depending on the location of melt pool 32 and the relationship of melt pool 32 to the underlying shape of component 22. At edges or corners, or over topological defects (e.g., protrusions or depressions on build surface 28, and or over concave or convex portions of build surface 28, melt pool 15 may capture data that indicates melt pool 32 as changing in size or shape.

For example, as melt pool 32 rolls over an edge, melt pool 32 may appear smaller to melt pool monitor 15 than the same melt pool would appear if positioned in a center section of build surface 28. Similarly, melt pool 32 may also appear differently to melt pool monitor 32 as it travels up or down an incline or over a wavy portion of build surface 28. In some examples, data captured by melt pool monitor 15 during deposition may be input into the machine learning model. The machine learning model may compare, from the same or previous additive manufacturing processes, and using data input that includes the geometry of component 22 and settings of powder delivery device 14 and energy delivery device 16 the appearance of the melt pool and output a target size of melt pool 32. In this way, by capturing and analyzing data collected during deposition of one layer in real time and then feeding back that information into the deposition of the subsequent layer, system 10 may allow for a more accurate assessment and choosing of the correct target size of melt pool 32.

FIG. 2 is a conceptual and schematic diagram illustrating example additive manufacturing system 100. Additive manufacturing system 100 of FIG. 2 may be an example of additive manufacturing system 10 of FIG. 1. System 100 includes an example powder flow monitoring system 50 configured to monitor powder flow between a powder delivery device 52 and a build surface (not shown in FIG. 2) during an additive manufacturing technique. Powder delivery device 52 may be an example of powder delivery device 14 of FIG. 1, and PFMS 50 may be an example of PFMS 18 of FIG. 1.

Powder delivery device 52 includes a deposition head 54 that carries a plurality of delivery nozzles 56. Plurality of delivery nozzles 56 output a powder stream 58 toward the build surface. As shown in FIG. 2, the powder stream 58 may be focused at convergence point CP, such that powder stream 58 is converging toward the focal plane and diverging away from the focal plane. As discussed above, deposition head 54 may further include energy delivery device 16, which is not illustrated in FIG. 2 for improved clarity. Powder delivery device 52 may define powder stream central axis L. In examples where powder delivery device 52 includes a single delivery nozzle 56, central axis L may pass through the single delivery nozzle. In some examples, as illustrated, powder delivery device 52 may include plurality of delivery nozzles 56, and powder stream central axis L may be defined as passing through a point equidistant from each of the plurality of delivery nozzle EP. Point EP may be the point equidistant from plurality of delivery nozzles 56 on the downstream end, relative to powder flowing through powder delivery device 52, of powder delivery device 52. Point CP may be the point at which powder from the plurality of delivery nozzles 56 converges, which may be at the build surface (28, FIG. 1) of a component. In some examples, the energy delivery device (not illustrated in FIG. 2 for clarity), may be configured to deliver energy to the build surface parallel to (e.g., coincident with) powder stream central axis L.

PFMS 18 includes a housing 60 (also referred to as an enclosure), which encloses an imaging device 62 and an illumination device 64. In some examples, imaging device 62 may be a high-speed camera and illumination device 64 may be laser illuminator. Housing 60 is attached to an adjustable z-stage 66 by a bracket 68.

Housing 60 may enclose imaging device 62 and illumination device 64 and help protect imaging device 62 and illumination device 64 from a surrounding environment. For instance, housing 60 may surround imaging device 62 and illumination device 64 and prevent any powder that reflects from the build surface toward PFMS 18 from impacting imaging device 62 or illumination device 64.

Further, housing 60 may be configured to cool imaging device 62 and illumination device 64. Imaging device 62 and illumination device 64 may be exposed to heat from the melt pool at the build surface and energy from the energy delivery device. Imaging device 62 and illumination device 64 may be relatively sensitive to heat and have improved operational lifetime if maintained and operated below a certain temperature. PFMS 50 may include a cooling system 70 that removes heat from within housing 60 to cooling imaging device 62 and illumination device 64. For instance, cooling system 70 may include cooling fluid circuit through which a cooling fluid flows, and housing 60 may include part of the cooling circuit. In some examples, housing 60 may be formed from a material having relatively high thermal conductivity, such as aluminum, to help transfer heat from within housing 60 to cooling system 70 (e.g., a cooling fluid flowing through cooling system 70).

As described above, PFMS 50 may be configured to measure powder flow of powder stream 58 at one or more axial (or longitudinal) locations of powder stream 58 and determine one or more parameters associated with the powder flow. For instance, PFMS 50 may be determine a position of powder stream, either absolutely with respect to system 100 or with respect to deposition head 54, the position of which may be known relative to system 100. For instance, illumination device 64 may illuminate powder of powder stream 58 in a plane oriented substantially orthogonal to a longitudinal axis that extends from powder delivery device 52 to the build surface. PFMS 50 may be positioned at a selected axial or longitudinal location to image a selected axial or longitudinal position between powder delivery device 52 and the build surface. Imaging device 62 may be a camera configured to image at least some of the illuminated powder. PFMS 50 may include a computing device (e.g., computing device 12 of FIG. 1) configured to analyze images captured by imaging device 62 to identify a number of particle detections in each captured image and, optionally, derive further parameters from the number of particle detections. As such, computing device 12 may receive image data representing an image captured by imaging device 62. The image data may include representations of illuminated powder of powder stream 58, as imaged by imaging device 62 (e.g., as captured in an image frame by imaging device 62). Computing device 12 may generate a representation of powder stream based on the image data and output the representation of the powder stream for display at a display device.

In some examples, computing device 12 may determine a powder mass flow represented by the image data. To do so, computing device 12 may identify a number of powder particles within each image frame. In some examples, computing device 12 additionally may identify a size and/or shape of each powder particle within each image frame. Computing device 12 may implement any suitable image analysis technique to identify powder particles, and, optionally, size and/or shape of powder particles. Since the position of imaging device 62, either absolutely within additive manufacturing system 100 or relatively with respect to associated deposition head 54, may be known, the position of powder stream 58 may be determined by the position of powder stream 58 within the image frame.

Once computing device 12 has identified a number of powder particles within an image frame, computing device 12 may determine a mass flow based on the number of powder particles. For example, computing device 12 may determine the mass flow based on a calibration equation or calibration curve. The relationship between particle detections and mass flow may be determined experimentally. For instance, the relationship between particle detections and mass flow may be determined for each powder type (e.g., composition, size distribution, or both), as each powder type may have a different relationship between particle detections and mass flow. The relationship may be determined experimentally by flowing a known mass of powder at a known rate, and imaging the powder. By doing this multiple times at multiple rates, the calibration curve may be generated. The curve, in the form of an equation, a look-up table, or the like, may be stored in computing device 12, and computing device 12 may use the calibration curve to determine mass flow of a similar type of powder at a different flow rate based on particle detections.

In some examples, computing device 12 may receive image data representative of a sequence of images of illuminated powder in powder stream 58. Each image may be associated with a time. As such, computing device 12 may select one or more images of the sequence of images and analyze the one or more images. For each selected image, computing device 12 may identify a number of particle detections and, optionally, determine a mass flow associated with powder stream 58 for each image frame.

As described above, system 10 may include both mass flow monitoring and heat flow monitoring. FIG. 1 best illustrates the mass flow monitoring aspects of system 10. FIG. 3 is a conceptual block diagram illustrating further aspects of system 10, best illustrating the heat flow monitoring aspects of the example system. System 10 includes an optical system 80 for observing thermal emissions around melt pool 32, MP monitor 15 which includes a thermal camera for monitoring one or more parameters (e.g., a size, temperature, or the like) of melt pool 32, and an optional off-axis camera 21. Identical reference numerals in FIGS. 1 and 3 refer to the same parts. Further, those common parts are the same or substantially identical, aside from any differences described herein. As shown in FIG. 3, energy delivery device 16 includes an optical system 80.

During additive manufacturing, component 22 is built up by adding material to component 22 in sequential layers. The final component is composed of a plurality of layers of material. Energy delivery device 16 may direct energy beam 34 at build surface 28 of first layer 24 to form melt pool 32. Powder delivery device 14 may deliver powder stream 30 to melt pool 32, where at least some of the powder at least partially melts and is joined to first layer 24. Melt pool 32 cools as energy beam 34 is no longer delivered to that location of first layer 24 (e.g., due to energy delivery device 16 scanning energy 34 over the surface of first layer 24). The temperature and cooling rate of melt pool 32 and the surrounding areas of first layer 24 affect the microstructure, porosity, temper, and other properties of component 22 formed using the additive manufacturing technique. Further, these and other properties of component 22 may be impacted by the size of melt pool 32. Optical system 80, MP monitor 15, and/or camera 21 may capture data indicative of parameters of melt pool 32 (e.g., a position such as a position of a center point of melt pool 32 and/or a size of melt pool 32), and computing device 12 may analyze the captured data and determine the position of melt pool 32, either absolutely within system 10 or relatively with respect to an associated deposition head (e.g., deposition head 54, FIG. 2).

Optical system 80 may include an imaging device and an associated optical train, which senses emissions at or near component 22 during the additive manufacturing technique. For example, optical system 80 may include a visible light imaging device, an infrared imaging device, or an imaging device that is configured (e.g., using a filter) to image a specific wavelength or wavelength range.

The optical train may include one or more reflective, refractive, diffractive optical components configured to direct light to the imaging device. For example, the optical train may be configured to direct light from near component 22 and/or melt pool 32 to the imaging device. In some examples, at least a portion of the optical train is coaxial with the axis at which energy delivery device 16 outputs energy, and the at least a portion of the optical train may be attached to or otherwise configured to move with the portion of energy delivery device 16 that directs or focuses energy 34 at or near the surface of component 22. In this way, optical system 80 may move with energy delivery device 16 and track melt pool 32 as melt pool 32 moves across component 22, without needing to correct for any offsets between energy delivery device 16 and optical system 80 and/or needing to correct for geometry of component 22. In other examples, the optical train may not be coaxial with the axis at which energy delivery device 16 outputs energy 34, and computing device 12 may be configured to compensate for the offset and any affects this may have on the imaging, including shadowing, interference, geometry of component 22, or the like. Off-axis camera 21, which is a second camera not coaxial with the axis at which energy delivery device 16 outputs energy beam 34. Off-axis camera 21 may be configured to determine the position of melt pool 32 within system 10 by imaging energy 34 and/or melt pool 32 from a known (e.g., fixed) position within system 10.

In some examples, optical system 80 may include an occulting device. The occulting device is configured to reduce or block emissions (e.g., thermal emissions) that originate from the energy output by energy delivery device 16 and/or near a center of melt pool 32, which otherwise obfuscate emissions from solidifying regions of material at or near the edge of melt pool 32 and outside of melt pool 32. The occulting device may be a rigid occulting device or a dynamic occulting device. A rigid occulting device reduces or blocks emissions from a fixed region, e.g., from the energy 34 output by energy delivery device 16. For instance, a rigid occulting device may include a device with fixed dimensions that is opaque to wavelengths of interest. As another example, a rigid occulting device may include an apodizing lens in which a center of the lens if substantially opaque to wavelengths of interest and opacity decreases as a function of radius.

A dynamic occulting device is configured to be controlled to occult different regions, e.g., different sizes and/or shapes. A dynamic occulting device may include a rigid occulting device that is mounted to a device that can translate the rigid occulting device along and/or perpendicularly to the optical axis. As another example, a dynamic occulting device may include an opaque and viscous liquid, such as mercury, contained between two substrates. The substrates are substantially transparent to the wavelength(s) of interest. One or both of the substrates may be movable relative to the other substrate to control the distance between the substrates. By reducing the distance between the substrates, the size of the occulting region may increase. By increasing the distance between the substrates, the size of the occulting region may decrease. As a third example, a dynamic occulting device may include a digital micromirror device. Computing device 12 may control the micromirrors of the digital micromirror device to direct emissions that originate from energy 34 output by energy delivery device 16 and/or near a center of the melt pool away from the imaging device. A digital micromirror device may enable control of both the size and shape of the region of emissions that are occulted. As will be further discussed below, computing device 12 may a digital micromirror device within energy delivery device 16, which may be a galvanometer, or another digital micromirror device, to adjust the position of energy 34, and thus the position of melt pool 32.

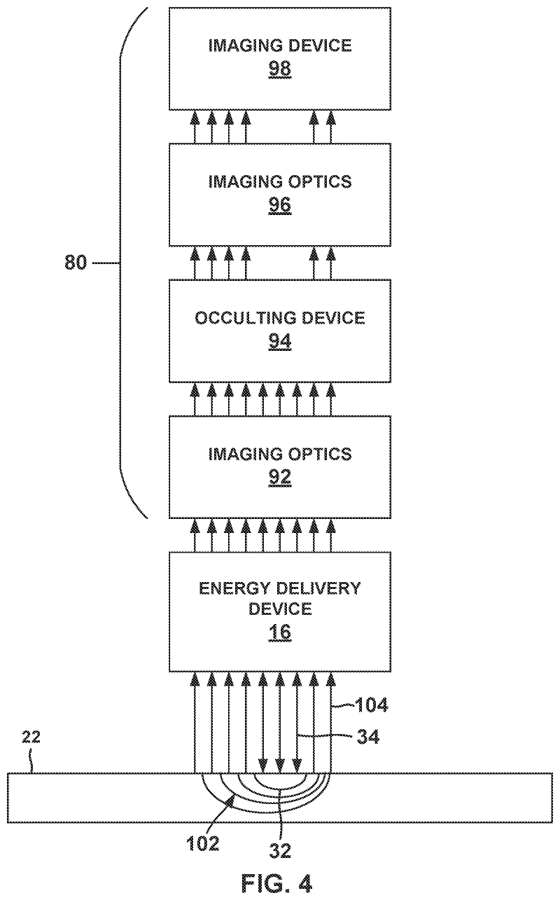

FIG. 4 is a conceptual block diagram illustrating an example optical system 80 for observing thermal emissions at and/or around a melt pool 32 and or a focused spot on a build surface 28 where a melt pool is not formed during an additive manufacturing technique. Optical system 80 includes an optical train that includes first imaging optics 92, occulting device 94, second imaging optics 96, and imaging device 98. Imaging device 98 may be any suitable imaging device, including, for example, a visible light imaging device, an infrared imaging device, an imaging device that is configured (e.g., using a filter) to image a specific wavelength or wavelength range, a two color pyrometry imaging device, or the like.

First and second imaging optics 92 and 96 may each include one or more optical devices used to direct light to imaging device 98. For example, First and second imaging optics 92 and 96 may each include one or more refractive optical device (e.g., a lens), one or more reflective optical device (e.g., a mirror), one or more diffractive optical devices (e.g., a grating), one or more dichroic optical devices (e.g., a dichroic filter or mirror), or the like. Although two sets of imaging optics 92 and 98 are shown in FIG. 4, in other examples, system 80 may include a single set of imaging optics or more than two sets of imaging optics.

Occulting device 94 is positioned within the optical train between first imaging optics 92 and second imaging optics 96. In other example, occulting device 94 may be positioned between imaging device 98 and imaging optics 96 or after before imaging optics 92. In some examples, occulting device 94 is positioned as the optical component nearest imaging device. This effectively results in removal of the portion of the image which occulting device 94 blocks. In other examples, occulting device 94 is positioned at another position within the optical train 80 where the image of component 22 resolves. Imaging optics 96 then may be configured to image occulting device 94 onto imaging device 98.

As shown in FIG. 4, in some examples, at least a portion of optical system 80 is coaxial with the axis at which energy delivery device 16 outputs energy 34. For example, at least a portion of second imaging optics 92 (e.g., the portion at which thermal emissions 104 is incident upon second imaging optics 92) may be coaxial with the axis at which energy delivery device 16 outputs energy 34. This may reduce image manipulation that otherwise may be applied to the resulting image to correct for geometry of component 22, angular offset of optical system 80 relative to energy delivery device 16, shadowing due to the angular offset, interference, or the like. In other examples, optical system 80 (e.g., the portion at which thermal emissions 104 are incident upon second imaging optics 92) may not be coaxial with the axis at which energy delivery device 16 outputs energy 34, and computing device 12 (FIG. 1) or another computing device may manipulate the resulting image to compensate for geometry of component 22, angular offset of optical system 80 relative to energy delivery device 16, shadowing due to the angular offset, interference, or the like.

FIG. 4 also illustrates energy delivery device 16 outputting energy 34, which is incident upon component 22 and results in formation of melt pool 32. Surrounding melt pool is a cooling zone 102, in which temperature gradients from the temperature of melt pool 32 to ambient temperature are present. As shown in FIG. 4, melt pool 32 and cooling zone 102 emit thermal emissions 104 (e.g., thermal radiation), which travel through optical system 80 to imaging device 98, which images the thermal emissions 104. Occulting device 94 occults (e.g., reduces the intensity of or substantially eliminates) thermal emissions 104 from a selected region, e.g., a region corresponding to energy 34 and at least a portion of melt pool 32. This may allow imaging device 98 to more effectively image relatively lower intensity thermal emissions from at or near the edge of melt pool 32 and within cooling zone 102. This may enable more accurate measurement of temperatures within the cooling zone 102, and heat flow within cooling zone 102.

Returning to FIG. 3, system 10 also includes melt pool monitor (“MP monitor”) 15. Melt pool monitor 15 may include one or more sensors for monitoring a characteristic of melt pool 32. The monitored characteristic may be indicative of a temperature of melt pool 32. For example, the one or more sensors of MP monitor 15 may include an imaging system, such as a visible or thermal camera, e.g., camera to visible light or infrared (IR) radiation. The visible light camera may capture data representative of the geometry of the melt pool and/or the surrounding build surface 28, e.g., a width, diameter, shape, or the like.

Computing device 12 may process the captured image data to determine a size and position of melt pool 32. In some examples, MP monitor 15 may detect the temperature of melt pool 32 at multiple positions within the melt pool, such as a leading edge, a center, and a trailing edge of the melt pool. In some examples, the imaging system may include a relatively high-speed camera capable of capturing image data at a rate of tens or hundreds of frames per second or more, which may facilitate real-time detection of the characteristic of melt pool 32. In some examples, MP monitor 15 may capture data at a sequence of particular points in time including a first point in time, a second point in time, etc. In some examples, data from melt pool monitor 15 may be analyzed by computing device 12 to determine a current position of melt pool 32 on build surface 28. For example, computing device 12 may determine a center point of melt pool 32. As mentioned above, computing device 12 may determine a size of melt pool 32. In some examples, the determined size may be based on a greatest dimension of melt pool 32 at build surface 28 (e.g., a distance from the leading edge of liquid material to the trailing edge of liquid material, a diameter of a substantially circular melt pool, a corner to corner distance of a rectangular melt pool, or the like).

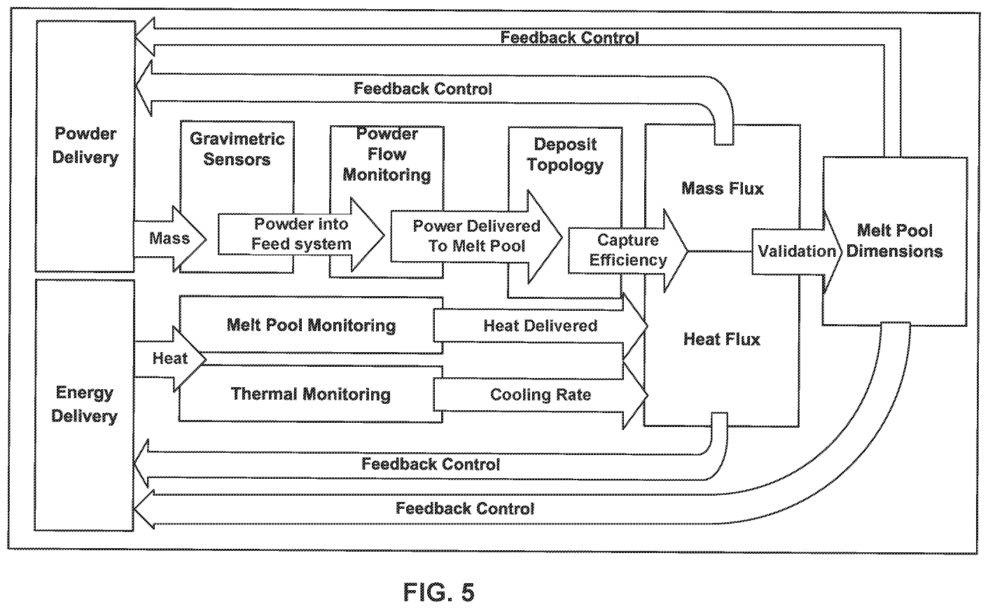

FIG. 5 is a process flow diagram illustrating an additive manufacturing monitor and control technique. The technique of FIG. 5 may be implemented by system 10 of FIGS. 1 and 3 and will be described with concurrent reference to FIGS. 1 and 3. However, it will be appreciated that system 10 may perform other techniques and the technique of FIG. 5 may be performed by other systems. For example, system 100 of FIG. 2 may perform the described technique.

One or more computing devices 12 may be configured to control a powder feed rate output by powder source 42 (see top left of FIG. 5). For instance, one or more computing devices 12 may be configured to control an agitator of powder source 42, a gas flow rate of gas flowing through powder source 42, a position of one or more valves within flow path 46, or the like to control a powder feed rate output by powder source 42.

One or more computing devices 12 may be configured to receive data from one or more mass flow monitoring sensors, including PFMS 18, powder flow mass sensor 44, and/or topology sensor 48. Data received from powder flow mass sensor 44 indicates a mass flow of powder from powder source 42 to powder delivery device. Data from PFMS 18 indicates a mass flow of powder in powder stream 30 between powder delivery device 14 to adjacent melt pool 32. Data from topology sensor 48 indicates powder mass captured by melt pool 32 and added to component 22.

One or more computing devices 12 may calculate one or more mass flow-related metrics based on the data received from PFMS 18, powder flow mass sensor 44, and/or topology sensor 48. For example, one or more computing devices 12 may determine a capture efficiency by determining a fraction or percentage of powder from powder stream 30 that is captured by melt pool 32 and added to component 22, e.g., by dividing the powder mass captured by melt pool 32, as determined based on data from topology sensor, into the mass flow determined based on data received from PFMS 18.

Further, one or more computing devices 12 may determine an overall mass flux using the data received from PFMS 18, powder flow mass sensor 44, and/or topology sensor 48. One or more computing devices 12 then may use the overall mass flux as an input to the control algorithm used to control the powder feed rate output by powder source 42 (see top left of FIG. 5). Additionally, one or more computing devices 12 may determine the position of powder stream 30, either absolutely within system 10 or relatively with respect to a deposition head.

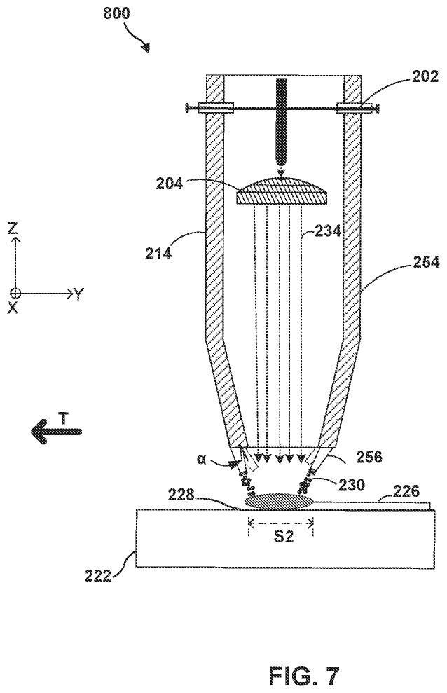

Similarly, one or more computing devices 12 may be configured to control energy delivery device 16 to deliver energy beam 34 to first layer 24 to establish a given heat input (see bottom left of FIG. 7). For example, one or more computing device 12 may control one or more operating parameters of energy delivery device 16, such as by maintaining or adjusting a spot size (e.g., by maintaining or adjusting a focus or working distance), an intensity, a pulse rate, a pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22).

One or more computing devices 12 may be configured to receive data captured by one or more thermal sensors, such as optical system 80 and/or melt pool monitor 15. One or more computing devices 12 may determine a cooling rate and associated heat from using data from optical system 80 and may determine a heat input into component 22 using the determined size and/or temperature of melt pool 32 as observed by melt pool monitor 15. In some examples, one or more computing devices 12 receive data captured by melt pool monitor 15, and may analyze the captured data to determine a position of melt pool 32 (e.g., a center point of melt pool 32).

In some examples, the technique of FIG. 5 includes validation of the dimensions of melt pool 32. For example, computing device 12 may determine the current size of melt pool 32 as described above. Based on the location of melt pool 32, computing device 12 may determine a desired melt pool size. Computing device 12 may control, based on the desired size of melt pool 32, energy delivery device 16 to form melt pool 32 of the desired size in build surface 28 of component 22. Computing device 12 may repeat the process of comparing the current size of melt pool 32 to the desired size of melt pool 32 to iterate and validate the formation of the melt pool of the desired size in build surface 28.

Computing device 12 may determine the desired size of melt pool 32 in one or more ways. For example, to determine the desired size of melt pool 32, computing device 12 may store a model of a fully formed version of component 22. The model of the desired final dimensions of fully formed component 22 may be divided into a matrix with a plurality of cells. For example, the matrix may include a plurality of rows, with each row corresponding to layers 24, 26 of the plurality of layers of component 22 and a plurality of columns, with each column corresponding to a portion of a plurality of portions of component 22. Each portion may be defined substantially parallel to the build direction of layers 24, 26. The model may store desired melt pool sizes at each cell of the matrix, along with other aspects of the build strategy (e.g., settings of system 10 such as power supplied to energy delivery device 16, mass flux, powder density, carrier gas flow rate, etc.). Computing device 12 may compare the current position of melt pool 32, as determined, for example, by captured data from melt pool monitor 15, to the model of the fully formed component 22 to determine the current location of melt pool 32 within the model, that is, which cell in the matrix contains the desired melt pool size corresponding to the particular current position. Computing device 12 may thus determine the desired size of melt pool 32 based at partially on the model of final component 22.

Additionally, or alternatively, as will further described below, in some examples computing device 12 may determine a desired size of melt pool 32 based at least partially on a sensed edge of previously deposited layer 24 of component 22. For example, a track may be positioned at an edge of component 22, and system 10 may deposit a track that aligns with the edge, even when the complex geometry of component 22 requires that the track vary in width. In some examples, computing device 12 may receive, from melt pool monitor 15 and/or optical system 80, data indicative of the geometry of build surface 28. Computing device 12 may determine at least one boundary (e.g., the edge) of build surface 28 based on the received data from melt pool monitor 15 and optical system 80, and determine the desired size of melt pool 32 based at least partially on the determined boundary or boundaries. In this way, by sensing an edge or edges of component 22, system 10 may deposit layer 26 with the same or similar dimensions as underlying layer 24. Advantageously, melting over the edge of layer 24 may be reduced or eliminated by modifying the size of melt pool 32, and thus the resulting track of deposited material, to conform to the edge of component 22.

Additionally, or alternatively, as will be further described below, computing device 12 may determine a desired size of melt pool 32 based at least partially on the topology of build surface 28. For example, topology sensor 48, which in some cases may be a laser profilometer, may scan build surface 28 and output data indicative of the topology of build surface 28 in the area of melt pool 32. Computing device 12 may receive the topological data from topology sensor 48 and identify, based on the received data, a deviation in build surface 28. For example, the received topological data from topology sensor 48 may be compared to specification data representative of a set of tolerances of build surface 28 to identify the deviation. The deviation may be a depression or crack in build surface 28, or may be a relatively high area such as a ridge or protrusion. The deviation may result from melt pool splatter (e.g., material ejected from melt pool 32), unmelted powder from powder stream 30 adhering to build surface 28, or the like. Computing device 12 may control energy delivery device 16 to modify the size of melt pool 32 in the area of build surface 28 where the deviation is recognized, based on an algorithm, look-up-table, machine learning model, or the like. The algorithm, look-up-table, or machine learning model may store or output a desired melt pool size for the identified deviation.

In cases where a machine learning model is used, the machine learning model may be trained on data from previously identified deviations and/or corrective actions. For example, a protrusion cause by unmelted powder at build surface 28 may be identified and at least partially repaired by increasing the size of melt pool 32 at or near the protrusion, which may melt the unmelted powder and flatten the build surface in the area of the protrusion. In this way, system 10 may determine a desired size of melt pool 32 based on the position of melt pool 32 based on a model of component 22, a sensed boundary of component 22, and/or a topology of build surface 28.

In some examples, the desired size of melt pool 32 may be determined based on a combination of the above-described techniques. For example, the desired size of melt pool 32 may be initially determined by comparison to the model of the fully formed version of component 22. The output desired size of melt pool 32 may be modified by a determined boundary of component 22 and/or an identified deviation in build surface 22. In this way, the desired size of melt pool 32 may be determined by computing device 12 based on a combination of techniques.

To control the energy delivery device to form melt pool 32 at the desired size, computing device 12 may include logic for deciding whether an adjustment to the current size of melt pool 32 is necessary. For example, computing device 12 may determine whether the current size of melt pool 32 meets a threshold for matching the desired size of melt pool 32. Responsive to determining that the current size of melt pool 32 does not meet the threshold for matching the desired size of melt pool 32, computing device 12 may adjust the size of melt pool 32 by modifying energy delivery device 16 (e.g., adjust the focus or working distance of energy delivery device 16). In some examples, melt pool 32 may be substantially circular, and computing device 12 may vary melt pool 32 in diameter from about 0.1 millimeters (mm) to about 5 mm, such as from about 0.4 mm to about 3 mm. In some examples, the threshold for matching the desired size of the melt pool may be about plus or minus (+/−) 5 percent (%), or about 10%, or about 20%.

Maintaining or adjusting the current size of melt pool 32 to meet the threshold for matching the desired size of melt pool 32 by control of energy delivery device 16 may be accompanied by manipulation of other settings of system 10 by computing device 12. For example, computing device 12 may manipulate a power density of energy delivery device 12 by modifying a power supplied to energy delivery device 16. In some examples, computing device 12 may maintain the energy density supplied to melt pool 32 as the size of melt pool 32 varies. Computing delivery device 12 may additionally or alternatively control powder delivery device 14 based at least partially on the size of melt pool 32. With reference to FIG. 2, computing device 12 may control a position (e.g., a delivery angle) of delivery nozzles 56.

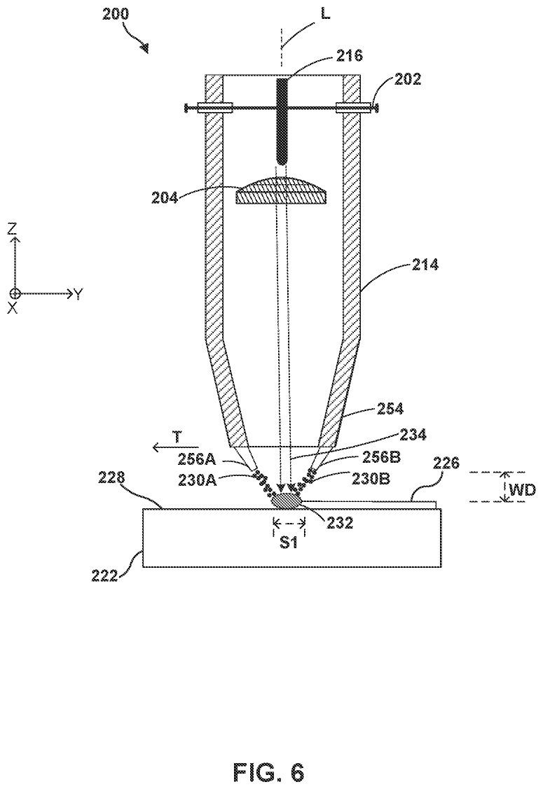

FIGS. 6 and 7 are conceptual and schematic diagrams illustrating a portion of additive manufacturing system 200. System 200 may be an example of system 10 of FIGS. 1 and 3 or system 100 of FIG. 2. System 200 includes deposition head 254, which includes both powder delivery device 214 and energy delivery device 216. Several additional components, including one or more computing devices, cameras, and sensors as described above with respect to system 10 and system 100 are not illustrated in FIGS. 6 and 7 for clarity. Components not illustrated in FIGS. 6 and 7 are described with respect to system 10 of FIGS. 1 and 5.

Deposition head 254 includes energy delivery device 216, which may generate and/or delivery energy beam 234 to build surface 228 of component 222 to form melt pool 232. Deposition head 254 includes powder delivery device 214, which directs powder stream 230 to the melt pool. Powder in powder stream 230, at least some of which may be at least partially melted by energy 234 while in flight across working distance WD, is captured by melt pool 232, and solidifies to form layer 226 on component 222 during the additive manufacturing process. Computing device 12 may cause deposition head 254 to travel along a toolpath, indicated by arrow T in FIGS. 6-7, and the relative position of powder stream 230 to melt pool 232 may be maintained as deposition head 254 travels along toolpath T to deposit layer 226.

Deposition head 254 houses energy delivery device 216, which in the illustrated example is a laser. Energy delivery device 216 may reside in a cavity within deposition head 254, and may be supported by one or more adjustable support members 202. In operation, computing device 12 may control adjustable support members 202 in one or more of the X, Y, or Z directions, via, for example, an electrical connection. Computing device 12 may actuate adjustable support members 202 to adjust the position of energy delivery device 216 within deposition head 254. In this way, computing device 12 may control the position of melt pool 232 on build surface 228, and thus may control the spot size of energy beam 234. In some examples, energy delivery device 216 may include optical train 204, which may include a plurality of mirrors and/or lenses configured to position and shape energy beam 234. Adjustment of optical train 204 by computing device 12 may allow for selective tailoring of the spot size, position, frequency, polarity, and/or other aspects of energy beam 234 delivered to build surface 228 to form melt pool 232.

Powder travels from powder source 42 through powder delivery device 214 via channels formed in the walls of deposition head 254, and exits delivery nozzles 256A, 256B (collectively, “delivery nozzles 256”) as powder stream 230A, 230B (collectively, “powder stream 230”). Powder stream 230 traverses working distance WD between delivery nozzles 256 and build surface 228. Delivery nozzles 256 may be controlled independent of energy delivery device 216 by computing device 12 to adjust the position of powder stream 230 relative to melt pool 232. For example, delivery nozzles 256 may direct powder stream 230 towards melt pool 232 at an angle, and the angle may be adjusted by computing device 12. Similarly, the orifice size or position of delivery nozzles 256 may be adjusted by computing device 12, in examples where powder delivery device 214 allows for these parameters to be adjusted in situ.

FIG. 6 illustrates deposition of layer 226 by deposition head 254 during a first point in time during an additive manufacturing operation of component 222, and FIG. 7 illustrates deposition head 254 during a second point in time during the operation. At the first point in time of FIG. 6, energy delivery device 216 forms melt pool 232 at first size S1, and at the second point in time of FIG. 7, energy delivery device 216 forms melt pool 232 at second size S2. As illustrated, sizes S1 and S2 are different from each other. In some examples, as illustrated, computing device 12 may manipulate optical train 204 to adjust size of melt pool 232 between sizes S1 and S2.

As further illustrated by the broken lines of FIG. 7, responsive to varying the size of melt pool 232 from size S1 of FIG. 6 to size S2 of FIG. 7, computing device 12 may manipulate other variables of system 200. For example, computing device 12 may adjust the angle of delivery nozzles 256 by angle α. Adjusting the angle of delivery nozzles 256 by angle α may manipulate the convergence point of powder stream 230. In this way, responsive to the changing size of melt pool 232, computing device 12 may manipulate the addition of powder to melt pool 232, for example to more evenly distribute powder stream 230 throughout a larger melt pool.

Computing device 12 may manipulate a power supplied to energy delivery device 216 to control an energy density supplied to melt pool 232. Energy density is represented in FIGS. 6 and 7 by the density of the broken lines indicating energy beam 234. Computing device 12 may increase the power supplied to energy delivery device 12 from the first point in time of FIG. 6 to the second point in time of FIG. 7, responsive to the increased size of melt pool 232. In some examples, computing device 12 may maintain the energy density of energy beam 234 to melt pool 232 as the melt pool increases in size from size S1 to size S2, as illustrated by the substantially similar density of broken lines.

FIGS. 8A-8D are conceptual and schematic diagrams illustrating system 300 during an additive manufacturing operation where layer 326 is deposited on component 322. System 300 may be an example of system 10 of FIGS. 1 and 3 or system 100 of FIG. 2, where similar reference numerals indicate similar elements. FIGS. 8A-8D illustrate deposition of a layer 326, progressing from before the track begins in FIG. 8A to completion of the track in FIG. 8D. Component 322 includes build surface 328, which varies in width from a relatively wide portion P1 to a relatively narrow portion P2.

FIG. 8B illustrates deposition of layer 326 by deposition head 354 as deposition head 354 travels along toolpath T in relatively wide portion P1. To completely cover build surface 328 in wide portion P1, melt pool 332 may be relatively large, defining size D1. In some examples, size D1 may be a diameter, and may be about 3 mm. As used herein, the term about encompasses the stated value and those values within 10% of the stated value. To maintain a proper energy density for the relatively large melt pool, the power supplied to the energy delivery device (not illustrated) may be about 2 kilowatts (kW).

Deposition head 354 may progress further along toolpath T to deposit layer 326 on relatively narrow portion P1, as illustrated by FIG. 8C. To deposit layer 326 on the relatively narrow portion P1, computing device 12 may manipulate the energy delivery device to change the size of melt pool 332 such that melt pool 332 defines relatively smaller size D2. In some examples, size D2 may be about 0.4 mm. To maintain final material properties of layer 326, computing device 12 may reduce the power supplied to the energy delivery device to maintain about the same energy density. In some examples, the energy supplied to the energy delivery device in FIG. 8C may be about 100 W. Deposition head 354 may continue to progress along the toolpath T until completing a single pass across build surface 328, depositing layer 326 in a single track as illustrated in FIG. 8D. In this way, by varying the size of melt pool 332, system 300 may deposit layer 326 as a single track, even where component 322 defines a complex geometry including relatively wide portions P1 and relatively narrow portions P2. Relative to a layer deposited in multiple tracks, layer 326 may define more uniform material properties.

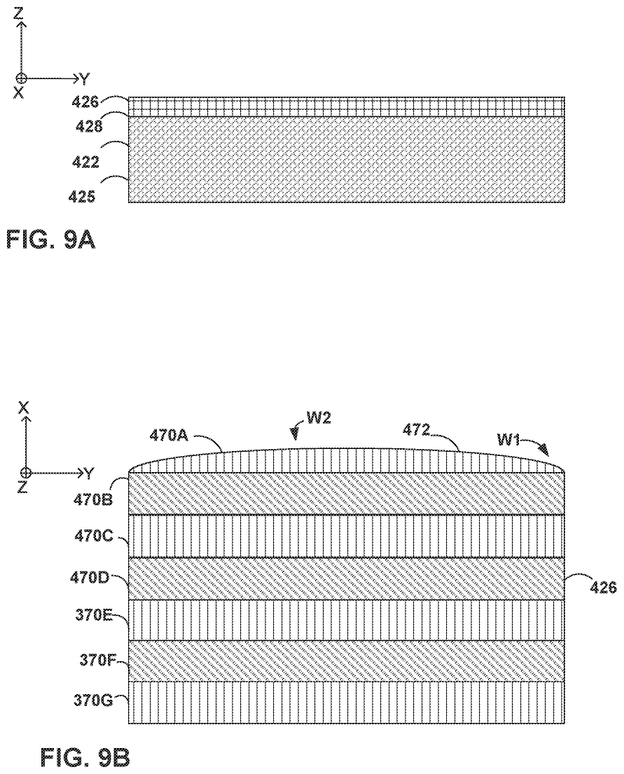

FIGS. 9A and 9B are conceptual views of an example additively-manufactured component 422 from a side and top view, respectively. Component 422 may be additively manufactured with systems and techniques according to the present disclosure. Component 422 includes component body 425 and additively-manufactured coating layer 426 disposed on component body 425. Layer 426 may be deposited (e.g., by system 10 of FIGS. 1 and 3) by deposition of tracks 470A-470G (collectively “tracks 470”). Tracks 470A-470G may be sequentially laid down by passing a deposition head (54, FIG. 2) back and forth over component body 425.

In some examples, as illustrated, component 422 may define a curved edge 472. Edge 472 may also be called a boundary of component 422. As such, it may be desirable to deposit track 470A, which is disposed on edge 472, with relatively narrow portion W1 and relatively wide portion W2, such that layer 426 conforms to edge 472. System 10 may deposit track 470A along edge 472 by varying the size of the melt pool along track 470A. In this way, both melting over edge 472 and increased overlap with track 470B may be reduced or avoided, which may increase the quality of component 422.

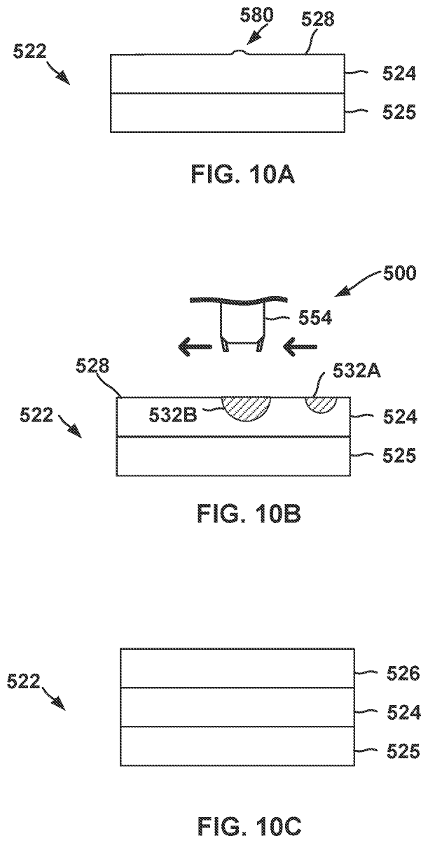

FIGS. 10A-10C are conceptual and schematic diagrams illustrating deposition head 554 of system 500 depositing layer 526 to form component 522. System 500 may be an example of system 10 of FIGS. 1 and 3, and similar reference numerals may describe similar elements.

Component 522 includes component body 525 and underlying layer 524 disposed on component body 525. Deposition head 554 may deposit layer 526 on build surface 528 of underlying layer 524. Underlying layer 524 includes deviation 580, which is a topological deviation from the substantially planar build surface 528.

Deviation 580 in the illustrated example of FIG. 10A is a protrusion, but in other examples may be another topological feature such as a depression, crack, ridge or the like. Deviation 580 may be caused by any one ore more of a number of events during an additive manufacturing process, such as melt pool splatter, agglomerations of material in powder stream 30, unmelted powder falling on surface 528, or the like. In any case, deviation 580 protrudes from the remainder of build surface 528. Deposition of layer 526 on deviation 580 without addressing or compensating for deviation in layer 526 resulting from deviation 580 may result in final component 522 missing a specification window, reduce proper adherence between layers 524 and 526, or otherwise cause deleterious effects. As described above, system 500 may include topology sensor 48 and computing device 12. Topology sensor 48 may capture topological data indicative of deviation 580, and computing device 12 may identify deviation 580 in the captured topological data. In some examples, computing device 12 may determine that deviation 580 causes layer 524 to fall outside a threshold specification window. Responsive to determining that deviation 580 causes layer 524 to fail to meet a specified tolerance, computing device 12 may determine that the size of the melt pool should be adjusted on or near deviation 580 as a corrective action. For example, computing device 12 may store one or more previous deviations, and may execute an algorithm, a lookup table, and/or a machine learning model trained on successful and/or unsuccessful corrective actions taken on these previous deviations. Based on the identified deviation 580, computing device 12 may control system 500 to form adjusted melt pool 532B on surface 528.

For example, as illustrated in FIG. 10B, as deposition head 554 travels along a toolpath, computing device 12 may cause melt pool 332A to increase in size to define melt pool 332B. The increased size of melt pool 332B may at least partially flatten deviation 580. As a result, layer 526 may be deposited with reduced or eliminated deviations, as illustrated in FIG. 10C. Accordingly, system 500 may vary the size of the melt pool to improve the topology, and thus the resulting quality, of component 522.

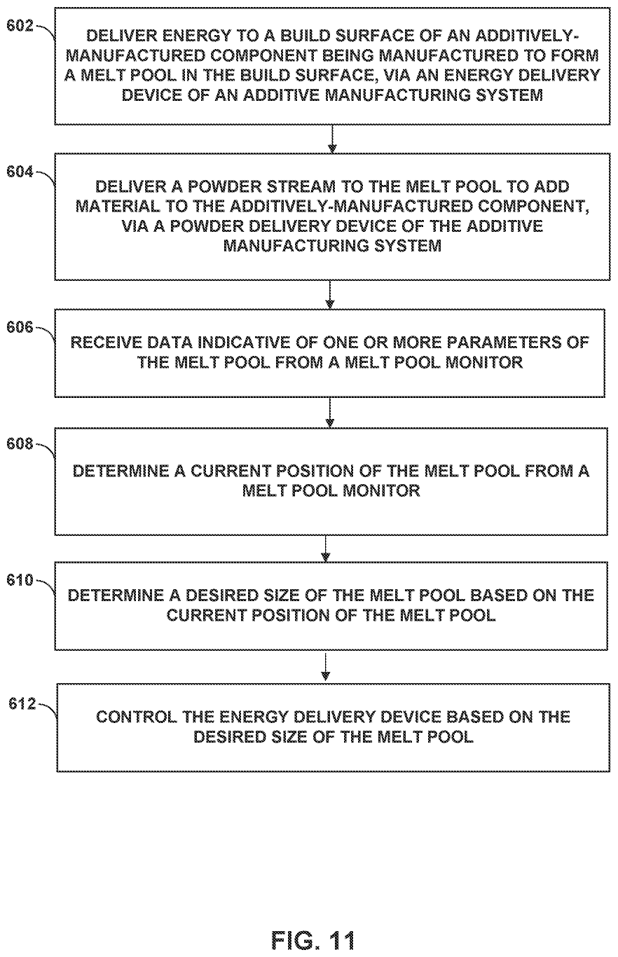

FIG. 11 is a flow diagram illustrating an example technique for additive manufacturing a component or coating based on the desired size of the melt pool. The technique of FIG. 11 may be executed by system 10 of FIGS. 1 and 3, system 100 of FIG. 2, system 200 f FIGS. 6 and 7, system 300 of FIGS. 8A-8D, or system 500 of FIG. 10B, and will be described as such, although other systems may be used to perform the described technique and other techniques may be performed using the described systems. The technique of FIG. 11 may be performed to additively-manufacture aerospace parts or coatings such as turbine blades or vanes and coatings disposed thereon.

Energy delivery device 16 may deliver energy beam 34 to build surface 28 of component 22 to form melt pool 32 in build surface 28 (602). Component 22 may, in some examples, be a gas turbine engine component. In some examples, component 22 may be define a complex geometry not defined by rectilinear polygons, for example relatively narrow features that may, in some cases, be smaller than can be manufactured by traditional additive manufacturing systems. In some cases, energy delivery device may be a laser. Example laser sources include a CO laser, a CO₂ laser, a Nd:YAG laser, or the like. In some examples, energy delivery device 16 may both generate and deliver energy 34. In some examples, energy 34 may be selected to provide energy with a predetermined wavelength or wavelength spectrum that may be absorbed by component 22 and/or the powder to be added to component 22 during the additive manufacturing technique.

Powder delivery device 14 may deliver powder stream 30 to melt pool 32 to add material to component 22 as layer 26 (604). In some examples, powder stream 30 may be powder entrained in a carrier gas or gases. The powder may include a metal or alloy, such that additively-manufactured component 22 includes a metal or an alloy. In some examples, powder delivery device 14 and energy delivery device 16 may be parts of a common deposition head 54. Deposition head 54 may travel along toolpath T to deposit layer 26 of material on a component during an additive manufacturing process.

Computing device 12 may receive data indicative of one or more parameters of melt pool 32 from melt pool monitor 15 (606). For example, melt pool monitor may be a camera which captures imaging data (e.g., visual and/or thermal imaging data) of build surface 28 and transmit the captured data to computing device 12. Computing device 12 may determine a current position of melt pool 32 based on the received data (608). The determined position of melt pool 32 may be relative to deposition head 54 or absolutely within system 10.

Computing device 12 may determine a desired size of melt pool 32 based on the determined position of melt pool 32 (610). In some examples, determining a desired size of melt pool 32 may include storing, by computing device 12, a model of the desired final additively-manufactured component 22. The model of desired final additively-manufactured component 22 may include desired melt pool sizes at each of a plurality of cells within a matrix. Computing device 12 may compare the determined position of melt pool 32 to the model of the desired final additively-manufactured component to the model of the desired final additively-manufactured component 22. Computing device 12 may determine the desired size of melt pool 32 based at least partially on the location of the melt pool within the model of the desired final additively-manufactured component 22.

In some examples, the desired size of melt pool 32 may be determined based on a sensed edge of component 22. With reference to FIGS. 9A and 9B, in some examples computing device 12 may receive from melt pool monitor 15 data indicative of the geometry of build surface 428. Computing device may determine at least one boundary of build surface 428, which in the illustrated example of FIGS. 9A and 9B is edge 472 based on the received data, and computing device 12 may determine the desired size of melt pool 32 based on the determined boundary.

In some examples, computing device 12 may determine the desired size of melt pool 32 based at least partially on topological data of build surface 28 captured by topology sensor 48. With concurrent reference to FIGS. 10A-10C, computing device 12 may receive from topology sensor 48, data indicative of the topology of build surface 528 in the area of the melt pool. Computing device 12 may identify deviation 580 in build surface 528, and determine the desired size of melt pool 532B based on the identified deviation.

Computing device 12 may control energy delivery device 16 based on the determined desired size of melt pool 32 (612). Computing device 12 may determine whether size of melt pool 32 meets a threshold for matching the desired size of melt pool 32. Responsive to determining that the size of melt pool 32 does not meet a threshold for matching the desired melt pool size, computing device 12 may adjust the size of melt pool 32 to meet the threshold for matching the desired size of melt pool 32 by modifying energy delivery device 16. In some examples, energy delivery device 16 is a laser, and modifying energy delivery device 16 may include modifying a focus of the laser or modifying a working distance WD of the laser. In some examples, computing device 12 may maintain a power density of energy delivery device 16 by modifying a power of the laser proportionally to the adjustment of the size of melt pool 32.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following examples and claims.

Example 1: An additive manufacturing system includes an energy delivery device configured to deliver energy to a build surface of an additively-manufactured component being manufactured to form a melt pool in the build surface of the component; a powder delivery device configured to direct a powder stream toward the melt pool; a melt pool monitor configured to observe the melt pool; and a computing device configured to: receive, from the melt pool monitor, data indicative of one or more parameters of the melt pool; determine, based on the received data, a current position of the melt pool; determine, based on the current position of the melt pool, a desired size of the melt pool; and control, based on the desired size of the melt pool, the energy delivery device to form the melt pool of the desired size in the build surface of the component.

Example 2: The additive manufacturing system of example 1, wherein, to determine the desired size of the melt pool, the computing device is configured to: store a model of a fully formed version of the additively-manufactured component, wherein the model of the fully formed additively-manufactured component includes desired melt pool sizes at each of a plurality of cells within a matrix, compare the position of the melt pool to the model of the desired final additively-manufactured component, determine the position of melt pool within the model of the desired final additively-manufactured component, and determine the desired size of the melt pool based at least partially on the position of the melt pool within the model of the desired final additively-manufactured component.

Example 3: The additive manufacturing system of any of examples 1 and 2, wherein, to determine the desired size of the melt pool, the computing device is configured to: receive, from the melt pool monitor, data indicative of a geometry of the build surface, determine at least one boundary of the build surface based on the received data from the melt pool monitor, and determine the desired size of the melt pool based at least partially on the determined at least one boundary of the build surface.

Example 4: The additive manufacturing system of any of examples 1 through 3, wherein, to determine the desired size of the melt pool, the computing device is configured to: receive, from a topology sensor, data indicative of the topology of the build surface in area vicinity of melt pool.

Example 5: The additive manufacturing system of example 4, wherein the topology sensor comprises a laser profilometer.

Example 6: The additive manufacturing system of any of examples 1 through 5, wherein the energy delivery device is a laser configured to deliver energy as an energy beam, wherein the energy beam is configured to impinge upon the build surface to form the melt pool in the build surface, and wherein a size of the melt pool is defined by the greatest dimension of the melt pool in a plane parallel to the build surface.

Example 7: The additive manufacturing system of any of examples 1 through 6, wherein, to control the energy delivery device to form the melt pool of the desired size in the build surface of the component, the computing device is configured to: determine, based on the received data, a current size of the melt pool; determine whether the current size of the melt pool meets a threshold for matching the desired size of the melt pool; and responsive to determining that the current size of the melt pool does not meet the threshold for matching the desired size of the melt pool, modifying the energy delivery device to form the melt pool with the desired size.

Example 8: The additive manufacturing system of example 7, wherein the energy delivery device is a laser, and to modify the energy delivery device, the computing device is configured to modify a focus of the laser or modify a working distance of the laser.

Example 9: The additive manufacturing system of example 8, wherein the computing device is configured to maintain, while modifying the energy delivery device, a power density of the energy delivery device by modifying a power of the laser proportionally to adjustment of the size of the melt pool.

Example 10: The additive manufacturing system of any of examples 1 through 9, wherein: the powder delivery device and the energy delivery device are parts of a deposition head, and the energy delivery device and the powder delivery device are independently controllable.

Example 11: The additive manufacturing system of example 10, wherein: the powder delivery device comprises one or more delivery nozzles from which the powder stream is directed, and to control the powder delivery device, the computing device is configured to control a position of the of the one or more delivery nozzles.

Example 12: The additive manufacturing system of example 11, wherein: individual portions of the powder stream are directed toward the melt pool from a plurality of delivery nozzles, the individual portions of the powder stream are configured to converge at a convergence point, and the computing device is configured to modify the convergence point by adjusting the powder delivery device in response to a change in the size of the melt pool.

Example 13: The additive manufacturing system of any of examples 1 through 12, further comprising the additively-manufactured component, wherein the additively manufactured component is a gas turbine engine component.

Example 14: A method includes delivering, via an energy delivery device, energy to a build surface of an additively-manufactured component being manufactured to form a melt pool in the build surface of the component; delivering, via a powder delivery device, a powder stream to the melt pool to add material to the component; receiving, from a melt pool monitor, data indicative of one or more parameters of the melt pool; determining, via a computing device, based on the received data, a current position of the melt pool; determining, via the computing device, based on the current position of the melt pool, a desired size of the melt pool; and controlling, via the computing device, based on the desired size of the melt pool, the energy delivery device to form the melt pool of the desired size in the build surface of the component.

Example 15: The method of example 14, further includes storing, by the computing device, a model of a fully formed version of the additively-manufactured component, wherein the model of a fully formed version of the additively-manufactured component includes desired melt pool sizes at each of a plurality of cells within a matrix; comparing, by the computing device, the position of the melt pool to the model of the desired final additively-manufactured component; determining, by the computing device, the position of melt pool within the model of the desired final additively-manufactured component; and determine the desired size of the melt pool based at least partially on the position of the melt pool within the model of the desired final additively-manufactured component.

Example 16: The method of any of examples 14 and 15, further includes receiving, from the melt pool monitor, data indicative of a geometry of the build surface, determining, by the computing device, at least one boundary of the build surface based on the received data from the melt pool monitor, and determining, by the computing device, the desired size of the melt pool based at least partially on the determined at least one boundary of the build surface.

Example 17: The method of any of examples 14 through 16, further includes receiving, from a topology sensor, data indicative of the topology of the build surface in an area of melt pool.

Example 18: The method of any of examples 14 through 17, further includes determining, by the computing device, whether the size of the melt pool meets a threshold for matching the desired size of the melt pool, and responsive to determining that the size of the melt pool does not meet a threshold for matching the desired melt pool size, adjusting, by the computing device, the size of the melt pool to meet the threshold for matching the desired size of the melt pool by modifying the energy delivery device.

Example 19: The method of example 18, wherein the energy delivery device is a laser, and wherein modifying the energy delivery device comprises modifying a focus of the laser or modifying a working distance of the laser.

Example 20: The method of example 19, further comprising maintaining a power density of the energy delivery device by modifying a power of the laser proportionally to the adjustment of the size of the melt pool.

What is claimed is:

1. An additive manufacturing system comprising:
an energy delivery device configured to deliver energy to a build surface of an additively-manufactured component being manufactured to form a melt pool in the build surface of the component;
a powder delivery device configured to direct a powder stream toward the melt pool;
a melt pool monitor configured to observe the melt pool; and
a computing device configured to:
receive, from the melt pool monitor, data indicative of one or more parameters of the melt pool;
determine, based on the received data, a current position of the melt pool;
determine, based on the current position of the melt pool, a desired size of the melt pool; and
control, based on the desired size of the melt pool, the energy delivery device to form the melt pool of the desired size in the build surface of the component.

2. The additive manufacturing system of claim 1, wherein, to determine the desired size of the melt pool, the computing device is configured to:
store a model of a fully formed version of the additively-manufactured component, wherein the model of the fully formed additively-manufactured component includes desired melt pool sizes at each of a plurality of cells within a matrix,
compare the position of the melt pool to the model of the desired final additively-manufactured component,
determine the position of melt pool within the model of the desired final additively-manufactured component, and
determine the desired size of the melt pool based at least partially on the position of the melt pool within the model of the desired final additively-manufactured component.

3. The additive manufacturing system of claim 1, wherein, to determine the desired size of the melt pool, the computing device is configured to:
receive, from the melt pool monitor, data indicative of a geometry of the build surface,
determine at least one boundary of the build surface based on the received data from the melt pool monitor, and
determine the desired size of the melt pool based at least partially on the determined at least one boundary of the build surface.

4. The additive manufacturing system of claim 1, wherein, to determine the desired size of the melt pool, the computing device is configured to:
receive, from a topology sensor, data indicative of the topology of the build surface in area vicinity of melt pool;
identify, based on the received data from the topology sensor, a deviation in the build surface, and
determine, based on the identified deviation in the build surface, the desired size of the melt pool.

5. The additive manufacturing system of claim 4, wherein the topology sensor comprises a laser profilometer.

6. The additive manufacturing system of claim 1, wherein the energy delivery device is a laser configured to deliver energy as an energy beam,
wherein the energy beam is configured to impinge upon the build surface to form the melt pool in the build surface, and
wherein a size of the melt pool is defined by the greatest dimension of the melt pool in a plane parallel to the build surface.

7. The additive manufacturing system of claim 1, wherein, to control the energy delivery device to form the melt pool of the desired size in the build surface of the component, the computing device is configured to:
determine, based on the received data, a current size of the melt pool; determine whether the current size of the melt pool meets a threshold for matching the desired size of the melt pool; and
responsive to determining that the current size of the melt pool does not meet the threshold for matching the desired size of the melt pool, modifying the energy delivery device to form the melt pool with the desired size.

8. The additive manufacturing system of claim 7, wherein the energy delivery device is a laser, and to modify the energy delivery device, the computing device is configured to modify a focus of the laser or modify a working distance of the laser.

9. The additive manufacturing system of claim 8, wherein the computing device is configured to maintain, while modifying the energy delivery device, a power density of the energy delivery device by modifying a power of the laser proportionally to adjustment of the size of the melt pool.

10. The additive manufacturing system of claim 1, wherein:
the powder delivery device and the energy delivery device are parts of a deposition head, and
the energy delivery device and the powder delivery device are independently controllable.

11. The additive manufacturing system of claim 10, wherein:
the powder delivery device comprises one or more delivery nozzles from which the powder stream is directed, and
to control the powder delivery device, the computing device is configured to control a position of the of the one or more delivery nozzles.

12. The additive manufacturing system of claim 11, wherein:
individual portions of the powder stream are directed toward the melt pool from a plurality of delivery nozzles,
the individual portions of the powder stream are configured to converge at a convergence point, and
the computing device is configured to modify the convergence point by adjusting the powder delivery device in response to a change in the size of the melt pool.

13. The additive manufacturing system of claim 1, further comprising the additively-manufactured component, wherein the additively manufactured component is a gas turbine engine component.

14. A method comprising:
delivering, via an energy delivery device, energy to a build surface of an additively-manufactured component being manufactured to form a melt pool in the build surface of the component;
delivering, via a powder delivery device, a powder stream to the melt pool to add material to the component;
receiving, from a melt pool monitor, data indicative of one or more parameters of the melt pool;
determining, via a computing device, based on the received data, a current position of the melt pool;
determining, via the computing device, based on the current position of the melt pool, a desired size of the melt pool; and
controlling, via the computing device, based on the desired size of the melt pool, the energy delivery device to form the melt pool of the desired size in the build surface of the component.

15. The method of claim 14, further comprising:
storing, by the computing device, a model of a fully formed version of the additively-manufactured component, wherein the model of a fully formed version of the additively-manufactured component includes desired melt pool sizes at each of a plurality of cells within a matrix;
comparing, by the computing device, the position of the melt pool to the model of the desired final additively-manufactured component;
determining, by the computing device, the position of melt pool within the model of the desired final additively-manufactured component; and
determine the desired size of the melt pool based at least partially on the position of the melt pool within the model of the desired final additively-manufactured component.

16. The method of claim 14, further comprising:
receiving, from the melt pool monitor, data indicative of a geometry of the build surface,
determining, by the computing device, at least one boundary of the build surface based on the received data from the melt pool monitor, and
determining, by the computing device, the desired size of the melt pool based at least partially on the determined at least one boundary of the build surface.

17. The method of claim 14, further comprising:
receiving, from a topology sensor, data indicative of the topology of the build surface in an area of melt pool,
identifying, by the computing device, based on the received data from the topology sensor, a deviation in the build surface, and
determining, based on the identified deviation in the build surface, the desired size of the melt pool.

18. The method of claim 14, further comprising:
determining, by the computing device, whether the size of the melt pool meets a threshold for matching the desired size of the melt pool, and
responsive to determining that the size of the melt pool does not meet a threshold for matching the desired melt pool size, adjusting, by the computing device, the size of the melt pool to meet the threshold for matching the desired size of the melt pool by modifying the energy delivery device.

19. The method of claim 18, wherein the energy delivery device is a laser, and wherein modifying the energy delivery device comprises modifying a focus of the laser or modifying a working distance of the laser.

20. The method of claim 19, further comprising maintaining a power density of the energy delivery device by modifying a power of the laser proportionally to the adjustment of the size of the melt pool.
